(19) United States
(12) Patent Application Publication
(10) Pub. No.: US 2024/0306023 A1
(43) Pub. Date: Sep. 12, 2024

(54) UPLINK CONTROL INFORMATION PAYLOAD AND ORDERING FOR NON-COHERENT JOINT TRANSMISSION AND SINGLE TRANSMISSION RECEPTION POINT CHANNEL STATE INFORMATION

(71) Applicant: QUALCOMM INCORPORATED, San Diego, CA (US)

(72) Inventors: Mostafa KHOSHNEVISAN, San Diego, CA (US); Chenxi HAO, Beijing (CN)

(21) Appl. No.: 18/261,980

(22) PCT Filed: Mar. 31, 2021
(86) PCT No.: PCT/CN2021/084355

§ 371 Date: Jul. 18, 2023

(51) Int. Cl. H04W 24/10; H04L 5/00

(52) U.S. Cl. CPC H04W 24/10; H04L 5/0057

(57) ABSTRACT

Methods, systems, and devices for wireless communications are described. A user equipment (UE) may receive an indication of first and second channel measurement resources (CMR) for measuring channel state information (CSI), each CMR associated with first and second transmission configuration indicator states (TCI). The UE may determine CSI for a joint transmission hypothesis which includes two rank indicators, two layer indicators, and two precoding matrix indicators, and may determine a priority for including each indicator in the CSI. In some cases, a UE may identify more than one CSI to transmit, and may determine an ordering of the one or more CSIs based on the CMR, and whether each of the one or more CSIs is associated with a single transmission hypothesis of the joint transmission hypothesis. Based on the various ordering rules of the CSI, the UE may generate and transmit CSI reporting.

### CROSS REFERENCE

The present Application is a 371 national stage filing of International PCT Application No. PCT/CN2021/084355 by KHOSHNEVISAN et al. entitled “UPLINK CONTROL INFORMATION PAYLOAD AND ORDERING FOR NON-COHERENT JOINT TRANSMISSION AND SINGLE TRANSMISSION RECEPTION POINT CHANNEL STATE INFORMATION,” filed Mar. 31, 2021, which is assigned to the assignee hereof, and which is expressly incorporated by reference in its entirety herein.

### FIELD OF TECHNOLOGY

The following relates to wireless communications, including details of uplink control information payload and ordering for non-coherent joint transmission (NCJT) and single transmission reception point (TRP) channel state information (CSI).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

A UE may send channel state information (CSI) reports to a base station in a wireless communications network. Some conventional CSI reporting techniques, however, may be deficient.

### SUMMARY

The described techniques relate to improved methods, systems, devices, and apparatuses that support details of uplink control information payload and ordering for non-coherent joint transmission (NCJT) and single transmission reception point (TRP) channel state information (CSI). Generally, the described techniques provide support for coordinated communications in the wireless communications system based on NCJT CSI which includes an ordering of two rank indicators (RIs), layer indicators (LIs), and pre-coding matrix indicators (PMIs). Further, the described techniques proved support for determining a priority ordering for channel state information (CSI) report packing and omission in uplink control information.

In some examples, a user equipment (UE) may receive a number of channel measurement resource (CMR) sets associated with one or more transmission configuration indicator (TCI) state. The UE may determine CSI which includes two RIs, LIs, and PMIs, and may determine an ordering of each of the RIs, LIs, and PMIs within their respective sets based on various factors. Additionally or alternatively, the UE may determine a number of CSI reports to be included in uplink control information (UCI), and may determine a packing or omission rule for including the CSI reports in the UCI based on associated single TRP or NCJT associations for the CSI reports, or based on other aspects of the CSI reporting configuration.

A method for wireless communications at a UE is described. The method may include receiving an indication of a first CMR and a second CMR in a CMR set, each configured for measuring CSI reference signals, the first CMR associated with a first TCI state and the second CMR associated with a second TCI state, determining CSI for a joint transmission hypothesis to be included in a CSI report, the CSI including two RIs, two PMIs, two LIs, or combinations thereof, each indicator of each pair of indicators associated with a respective one of either the first CMR or the second CMR, identifying, for inclusion in the CSI report, an ordering of each indicator in at least one of the pairs of indicators associated with the first CMR and the second CMR, and transmitting, to a base station, the CSI report that includes the ordering.

An apparatus for wireless communications at a UE is described. The apparatus may include a processor, memory coupled with the processor, and instructions stored in the memory. The instructions may be executable by the processor to cause the apparatus to receive an indication of a first CMR and a second CMR in a CMR set, each configured for measuring CSI reference signals, the first CMR associated with a first TCI state and the second CMR associated with a second TCI state, determine CSI for a joint transmission hypothesis to be included in a CSI report, the CSI including two RIs, two PMIs, two Us, or combinations thereof, each indicator of each pair of indicators associated with a respective one of either the first CMR or the second CMR, identify, for inclusion in the CSI report, an ordering of each indicator in at least one of the pairs of indicators associated with the first CMR and the second CMR, and transmit, to a base station, the CSI report that includes the ordering.

Another apparatus for wireless communications at a UE is described. The apparatus may include means for receiving an indication of a first CMR and a second CMR in a CMR set, each configured for measuring CSI reference signals, the first CMR associated with a first TCI state and the second CMR associated with a second TCI state, means for determining CSI for a joint transmission hypothesis to be included in a CSI report, the CSI including two RIs, two PMIs, two Us, or combinations thereof, each indicator of each pair of indicators associated with a respective one of either the first CMR or the second CMR, means for identifying, for inclusion in the CSI report, an ordering of each indicator in at least one of the pairs of indicators associated with the first CMR and the second CMR, and means for transmitting, to a base station, the CSI report that includes the ordering.

A non-transitory computer-readable medium storing code for wireless communications at a UE is described. The code may include instructions executable by a processor to receive an indication of a first CMR and a second CMR in a CMR set, each configured for measuring CSI reference signals, the first CMR associated with a first TCI state and the second CMR associated with a second TCI state, determine CSI for a joint transmission hypothesis to be included in a CSI report, the CSI including two RIs, two PMIs, two Us, or combinations thereof, each indicator of each pair of indicators associated with a respective one of either the first CMR or the second CMR, identify, for inclusion in the CSI report, an ordering of each indicator in at least one of the pairs of indicators associated with the first CMR and the second CMR, and transmit, to a base station, the CSI report that includes the ordering.

In some examples of the method, apparatuses, and non-transitory computer-readable medium described herein, identifying the ordering of each indicator in at least one of the pairs of indicators may include operations, features, means, or instructions for determining the ordering of each indicator in the at least one of the pairs of indicators based on a CMR ordering of the first CMR and the second CMR.

Some examples of the method, apparatuses, and non-transitory computer-readable medium described herein may further include operations, features, means, or instructions for receiving an implicit indication or an explicit indication of the CMR ordering.

In some examples of the method, apparatuses, and non-transitory computer-readable medium described herein, identifying the ordering of each indicator in at least one of the pairs of indicators may include operations, features, means, or instructions for determining the ordering of each indicator in the at least one of the pairs of indicators by associating a first indicator of the at least one of the pairs of indicators with the first CMR based on the first CMR being associated with a first CMR group and a second indicator of the at least one of the pairs of indicators with the second CMR based on the second CMR being associated with a second CMR group, the first CMR group and the second CMR group including the CMR set.

In some examples of the method, apparatuses, and non-transitory computer-readable medium described herein, identifying the ordering of each indicator in at least one of the pairs of indicators may include operations, features, means, or instructions for determining the ordering of each indicator in the at least one of the pairs of indicators based on an order of appearance of the first CMR and the second CMR in the CMR set.

In some examples of the method, apparatuses, and non-transitory computer-readable medium described herein, identifying the ordering of each indicator in at least one of the pairs of indicators may include operations, features, means, or instructions for identifying a first CSI reference signal resource identifier associated with the first CMR and a second CSI reference signal resource identifier associated with the second CMR and determining the ordering of each indicator in the at least one of the pairs of indicators based on respective values of the first CSI reference signal resource identifier and the second CSI reference signal resource identifier.

In some examples of the method, apparatuses, and non-transitory computer-readable medium described herein, the CMR associated with a first indicator may have a lesser value than the CMR associated with a second indicator.

Some examples of the method, apparatuses, and non-transitory computer-readable medium described herein may further include operations, features, means, or instructions for transmitting, to the base station, a capability of the UE to transmit the CSI report for the joint transmission hypothesis including the two RIs, two PMIs, two LIs, or a combination thereof.

A method for wireless communications at a UE is described. The method may include receiving an indication of a first CMR and a second CMR, each configured for measuring CSI reference signals, the first CMR associated with a first TCI state and the second CMR associated with a second TCI state, receiving a configuration for measuring CSI reference signals for a first CSI report that includes a first single transmission hypothesis associated with the first CMR, a second CSI report that includes a second single transmission hypothesis associated with the second CMR, and a third CSI report that includes a joint transmission hypothesis associated with both a third CMR and a fourth CMR, identifying, for inclusion in UCI, an ordering of the first CSI report, the second CSI report, and the third CSI report based on association of respective CSI with either single transmission or joint transmission hypotheses, and transmitting, to a base station, the UCI that includes the ordering.

An apparatus for wireless communications at a UE is described. The apparatus may include a processor, memory coupled with the processor, and instructions stored in the memory. The instructions may be executable by the processor to cause the apparatus to receive an indication of a first CMR and a second CMR, each configured for measuring CSI reference signals, the first CMR associated with a first TCI state and the second CMR associated with a second TCI state, receive a configuration for measuring CSI reference signals for a first CSI report that includes a first single transmission hypothesis associated with the first CMR, a second CSI report that includes a second single transmission hypothesis associated with the second CMR, and a third CSI report that includes a joint transmission hypothesis associated with both a third CMR and a fourth CMR, identify, for inclusion in UCI, an ordering of the first CSI report, the second CSI report, and the third CSI report based on association of respective CSI with either single transmission or joint transmission hypotheses, and transmit, to a base station, the UCI that includes the ordering.

Another apparatus for wireless communications at a UE is described. The apparatus may include means for receiving an indication of a first CMR and a second CMR, each configured for measuring CSI reference signals, the first CMR associated with a first TCI state and the second CMR associated with a second TCI state, means for receiving a configuration for measuring CSI reference signals for a first CSI report that includes a first single transmission hypothesis associated with the first CMR, a second CSI report that includes a second single transmission hypothesis associated with the second CMR, and a third CSI report that includes a joint transmission hypothesis associated with both a third CMR and a fourth CMR, means for identifying, for inclusion in UCI, an ordering of the first CSI report, the second CSI report, and the third CSI report based on association of respective CSI with either single transmission or joint transmission hypotheses, and means for transmitting, to a base station, the UCI that includes the ordering.

A non-transitory computer-readable medium storing code for wireless communications at a UE is described. The code may include instructions executable by a processor to receive an indication of a first CMR and a second CMR, each configured for measuring CSI reference signals, the first CMR associated with a first TCI state and the second CMR associated with a second TCI state, receive a configuration for measuring CSI reference signals for a first CSI report that includes a first single transmission hypothesis associated with the first CMR, a second CSI report that includes a second single transmission hypothesis associated with the second CMR, and a third CSI report that includes a joint transmission hypothesis associated with both a third CMR and a fourth CMR, identify, for inclusion in UCI, an ordering of the first CSI report, the second CSI report, and the third CSI report based on association of respective CSI with either single transmission or joint transmission hypotheses, and transmit, to a base station, the UCI that includes the ordering.

In some examples of the method, apparatuses, and non-transitory computer-readable medium described herein, the identifying of the ordering of the first CSI report, the second CSI report, and the third CSI report may include operations, features, means, or instructions for allocating the first CSI report and the second CSI report to a first portion of the UCI or allocating the third CSI report to the first portion of the UCI.

Some examples of the method, apparatuses, and non-transitory computer-readable medium described herein may further include operations, features, means, or instructions for ordering the first CSI report and the second CSI report based on corresponding CSI reference signal resource indicator values, where the CSI report corresponding to a lowest CSI reference signal resource indicator value may be first in the ordering.

Some examples of the method, apparatuses, and non-transitory computer-readable medium described herein may further include operations, features, means, or instructions for ordering the first CSI report and the second CSI report based on corresponding CMR groups for the CSI reports, where the CSI report associated with the first CMR group may be first in the ordering.

Some examples of the method, apparatuses, and non-transitory computer-readable medium described herein may further include operations, features, means, or instructions for ordering the first CSI report and the second CSI report based on corresponding CSI reference signal resource ID values, where the CSI report corresponding to a lowest CSI reference signal resource ID value may be first in the ordering.

Some examples of the method, apparatuses, and non-transitory computer-readable medium described herein may further include operations, features, means, or instructions for ordering the first CSI report and the second CSI report based on an order of appearance of corresponding CMRs for the first CSI report and the second CSI report in a CSI resource set, where the CMR appearing first in the CSI resource set may be first in the ordering.

Some examples of the method, apparatuses, and non-transitory computer-readable medium described herein may further include operations, features, means, or instructions for identifying a CSI report omission rule based on the ordering, where the CSI report omission rule may be applied for a second portion of the CSI reports multiplexed on uplink resources for transmission of the UCI.

In some examples of the method, apparatuses, and non-transitory computer-readable medium described herein, the UCI overlaps with at least one other UCI, the UCI multiplexed in accordance with the ordering of the first CSI report, the second CSI report, and the third CSI report.

In some examples of the method, apparatuses, and non-transitory computer-readable medium described herein, the ordering may include operations, features, means, or instructions for ordering the CSI reports first based on an order of the respective transmission hypothesis in the UCI, and second based on alternating sub-bands of the CSI reports.

In some examples of the method, apparatuses, and non-transitory computer-readable medium described herein, the ordering may include operations, features, means, or instructions for ordering the CSI reports first based on alternating sub-bands of the CSI reports and second based on an order of the respective transmission hypothesis in the UCI.

A method for wireless communications at a base station is described. The method may include transmitting, to a UE, an indication of a first CMR and a second CMR in a CMR set, each configured for measuring CSI reference signals by the UE, the first CMR associated with a first TCI state and the second CMR associated with a second TCI state and receiving, from the UE, a CSI report including CSI for a joint transmission hypothesis, the CSI including two RIs, two PMIs, two Us, or combinations thereof, each indicator of each pair of indicators associated with a respective one of either the first CMR or the second CMR, and an ordering of each indicator in at least one of the pairs of indicators associated with the first CMR and the second CMR.

An apparatus for wireless communications at a base station is described. The apparatus may include a processor, memory coupled with the processor, and instructions stored in the memory. The instructions may be executable by the processor to cause the apparatus to transmit, to a UE, an indication of a first CMR and a second CMR in a CMR set, each configured for measuring CSI reference signals by the UE, the first CMR associated with a first TCI state and the second CMR associated with a second TCI state and receive, from the UE, a CSI report including CSI for a joint transmission hypothesis, the CSI including two RIs, two PMIs, two Us, or combinations thereof, each indicator of each pair of indicators associated with a respective one of either the first CMR or the second CMR, and an ordering of each indicator in at least one of the pairs of indicators associated with the first CMR and the second CMR.

Another apparatus for wireless communications at a base station is described. The apparatus may include means for transmitting, to a UE, an indication of a first CMR and a second CMR in a CMR set, each configured for measuring CSI reference signals by the UE, the first CMR associated with a first TCI state and the second CMR associated with a second TCI state and means for receiving, from the UE, a CSI report including CSI for a joint transmission hypothesis, the CSI including two RIs, two PMIs, two Us, or combinations thereof, each indicator of each pair of indicators associated with a respective one of either the first CMR or the second CMR, and an ordering of each indicator in at least one of the pairs of indicators associated with the first CMR and the second CMR.

A non-transitory computer-readable medium storing code for wireless communications at a base station is described. The code may include instructions executable by a processor to transmit, to a UE, an indication of a first CMR and a second CMR in a CMR set, each configured for measuring CSI reference signals by the UE, the first CMR associated with a first TCI state and the second CMR associated with a second TCI state and receive, from the UE, a CSI report including CSI for a joint transmission hypothesis, the CSI including two RIs, two PMIs, two Us, or combinations thereof, each indicator of each pair of indicators associated with a respective one of either the first CMR or the second CMR, and an ordering of each indicator in at least one of the pairs of indicators associated with the first CMR and the second CMR.

In some examples of the method, apparatuses, and non-transitory computer-readable medium described herein, the ordering of each indicator in at least one of the pairs of indicators may be based on a CMR ordering of the first CMR and the second CMR.

Some examples of the method, apparatuses, and non-transitory computer-readable medium described herein may further include operations, features, means, or instructions for transmitting an implicit indication or an explicit indication of the CMR ordering.

In some examples of the method, apparatuses, and non-transitory computer-readable medium described herein, the ordering of each indicator in at least one of the pairs of indicators may be based on a first indicator of the at least one of the pairs of indicators associated with the first CMR of a first CMR group and a second indicator of the at least one of the pairs of indicators with the second CMR of a second CMR group, the first CMR group and the second CMR group including the CMR set.

In some examples of the method, apparatuses, and non-transitory computer-readable medium described herein, the ordering of each indicator in the at least one of the pairs of indicators may be based on an order of appearance of the first CMR and the second CMR in the CMR set.

In some examples of the method, apparatuses, and non-transitory computer-readable medium described herein, the ordering of each indicator in the at least one of the pairs of indicators based on respective values of a first CSI reference signal resource identifier associated with the first CMR and a second CSI reference signal resource identifier associated with the second CMR.

In some examples of the method, apparatuses, and non-transitory computer-readable medium described herein, the CMR associated with a first indicator may have a lesser value than the CMR associated with a second indicator.

Some examples of the method, apparatuses, and non-transitory computer-readable medium described herein may further include operations, features, means, or instructions for receiving, from the UE, a capability of the UE to transmit the CSI report for the joint transmission hypothesis including the two RIs, two PMIs, two Us, or a combination thereof.

A method for wireless communications at a base station is described. The method may include transmitting, to a UE, an indication of a first CMR and a second CMR, each configured for measuring CSI reference signals at the UE, the first CMR associated with a first TCI state and the second CMR associated with a second TCI state, transmitting, to the UE, a configuration for measuring CSI reference signals for a first CSI report that includes a first single transmission hypothesis associated with the first CMR, a second CSI report that includes a second single transmission hypothesis associated with the second CMR, and a third CSI report that includes a joint transmission hypothesis associated both a third CMR and a fourth CMR, and receiving, from the UE, UCI including the first CSI report, the second CSI report, and the third CSI report ordered based on association of respective CSI with either single transmission or joint transmission hypotheses.

An apparatus for wireless communications at a base station is described. The apparatus may include a processor, memory coupled with the processor, and instructions stored in the memory. The instructions may be executable by the processor to cause the apparatus to transmit, to a UE, an indication of a first CMR and a second CMR, each configured for measuring CSI reference signals at the UE, the first CMR associated with a first TCI state and the second CMR associated with a second TCI state, transmit, to the UE, a configuration for measuring CSI reference signals for a first CSI report that includes a first single transmission hypothesis associated with the first CMR, a second CSI report that includes a second single transmission hypothesis associated with the second CMR, and a third CSI report that includes a joint transmission hypothesis associated both a third CMR and a fourth CMR, and receive, from the UE, UCI including the first CSI report, the second CSI report, and the third CSI report ordered based on association of respective CSI with either single transmission or joint transmission hypotheses.

Another apparatus for wireless communications at a base station is described. The apparatus may include means for transmitting, to a UE, an indication of a first CMR and a second CMR, each configured for measuring CSI reference signals at the UE, the first CMR associated with a first TCI state and the second CMR associated with a second TCI state, means for transmitting, to the UE, a configuration for measuring CSI reference signals for a first CSI report that includes a first single transmission hypothesis associated with the first CMR, a second CSI report that includes a second single transmission hypothesis associated with the second CMR, and a third CSI report that includes a joint transmission hypothesis associated both a third CMR and a fourth CMR, and means for receiving, from the UE, UCI including the first CSI report, the second CSI report, and the third CSI report ordered based on association of respective CSI with either single transmission or joint transmission hypotheses.

A non-transitory computer-readable medium storing code for wireless communications at a base station is described. The code may include instructions executable by a processor to transmit, to a UE, an indication of a first CMR and a second CMR, each configured for measuring CSI reference signals at the UE, the first CMR associated with a first TCI state and the second CMR associated with a second TCI state, transmit, to the UE, a configuration for measuring CSI reference signals for a first CSI report that includes a first single transmission hypothesis associated with the first CMR, a second CSI report that includes a second single transmission hypothesis associated with the second CMR, and a third CSI report that includes a joint transmission hypothesis associated both a third CMR and a fourth CMR, and receive, from the UE, UCI including the first CSI report, the second CSI report, and the third CSI report ordered based on association of respective CSI with either single transmission or joint transmission hypotheses.

In some examples of the method, apparatuses, and non-transitory computer-readable medium described herein, receiving the UCI may include operations, features, means, or instructions for receiving the first CSI report and the second CSI report in a first portion of the UCI or receiving the third CSI report to the first portion of the UCI.

Some examples of the method, apparatuses, and non-transitory computer-readable medium described herein may further include operations, features, means, or instructions for receiving the first CSI report and the second CSI report in an order that based on corresponding CSI reference signal resource indicator values, where the CSI report corresponding to a lowest CSI reference signal resource indicator value may be first in the ordering.

Some examples of the method, apparatuses, and non-transitory computer-readable medium described herein may further include operations, features, means, or instructions for receiving the first CSI report and the second CSI report in an order that may be based on corresponding CMR groups for the CSI reports, where the CSI report associated with the first CMR group may be first in the ordering.

Some examples of the method, apparatuses, and non-transitory computer-readable medium described herein may further include operations, features, means, or instructions for receiving the first CSI report and the second CSI report in an order that may be based on corresponding CSI reference signal resource ID values, where the CSI report corresponding to a lowest CSI reference signal resource ID value may be first in the ordering.

Some examples of the method, apparatuses, and non-transitory computer-readable medium described herein may further include operations, features, means, or instructions for receiving the first CSI report and the second CSI report in an order that based on an order of appearance of corresponding CMRs for the first CSI report and the second CSI report in a CSI resource set, where the CMR appearing first in the CSI resource set may be first in the ordering.

In some examples of the method, apparatuses, and non-transitory computer-readable medium described herein, the UCI overlaps with at least one other UCI, the UCI multiplexed in accordance with the ordering of the first CSI report, the second CSI report, and the third CSI report.

Some examples of the method, apparatuses, and non-transitory computer-readable medium described herein may further include operations, features, means, or instructions for receiving the CSI reports in an order that may be first based on an order of the respective transmission hypothesis in the UCI, and second based on alternating sub-bands of the CSI reports.

Some examples of the method, apparatuses, and non-transitory computer-readable medium described herein may further include operations, features, means, or instructions for receiving the CSI reports in an order that may be first based on alternating sub-bands of the CSI reports corresponding to and second based on an order of the respective transmission hypothesis in the UCI.

### BRIEF DESCRIPTION OF THE DRAWINGS

FIG. 1 illustrates an example of a wireless communications system that supports details of uplink control information payload and ordering for non-coherent joint transmission (NCJT) and single transmission reception point (TRP) channel state information (CSI) in accordance with aspects of the present disclosure.

FIG. 2 illustrates an example of a wireless communications system that supports details of uplink control information payload and ordering for NCJT and single TRP CSI in accordance with aspects of the present disclosure.

FIG. 3 illustrates example uplink control information (UCI) packing configurations that support details of uplink control information payload and ordering for NCJT and single TRP CSI in accordance with aspects of the present disclosure.

FIGS. 4 and 5 illustrates an example process flows that supports details of uplink control information payload and ordering for NCJT and single TRP CSI in accordance with aspects of the present disclosure.

FIGS. 6 and 7 show block diagrams of devices that support details of uplink control information payload and ordering for NCJT and single TRP CSI in accordance with aspects of the present disclosure.

FIG. 8 shows a block diagram of a communications manager that supports details of uplink control information payload and ordering for NCJT and single TRP CSI in accordance with aspects of the present disclosure.

FIG. 9 shows a diagram of a system including a device that supports details of uplink control information payload and ordering for NCJT and single TRP CSI in accordance with aspects of the present disclosure.

FIGS. 10 and 11 show block diagrams of devices that support details of uplink control information payload and ordering for NCJT and single TRP CSI in accordance with aspects of the present disclosure.

FIG. 12 shows a block diagram of a communications manager that supports details of uplink control information payload and ordering for NCJT and single TRP CSI in accordance with aspects of the present disclosure.

FIG. 13 shows a diagram of a system including a device that supports details of uplink control information payload and ordering for NCJT and single TRP CSI in accordance with aspects of the present disclosure.

FIGS. 14 through 20 show flowcharts illustrating methods that support details of uplink control information payload and ordering for NCJT and single TRP CSI in accordance with aspects of the present disclosure.

### DETAILED DESCRIPTION

In some wireless communications systems, a user equipment (UE) may perform measurements of signals transmitted by one or more base stations or transmission reception points (TRPs), and may include these measurements in one or more channel state information (CSI) reports. In some cases, the UE may participate in multi-TRP (mTRP) operation, where a number of TRPs may communicate with the UE at a same time. This is in contrast to single TRP (sTRP) operation, where the UE communicates with a single TRP at a given time. In cases where the UE supports mTRP operations, the UE may engage in separate, or non-joint, transmissions with different single TRPs, or the UE may engage in non-coherent joint transmissions (NCJT) with a pair of TRPs. Thus, when providing CSI reports, the UE may provide CSI reports on a per-TRP basis (for sTRP operation) or for joint TRP communications (for mTRP operation).

To support coordinated communications in the wireless communications system, the UE may generate one or more CSI reports which may be NCJT CSI or sTRP CSI associated with one or more TRPs. Among other channel quality information, the UE may include a number of indicators in the CSI report, for example, the UE may include two rank indicators (RIs), two layer indicators (LIs) and two pre-coding matrix indicators (PMIs) in a CSI report. The UE may determine an ordering of each indicator within the set of two indicators based on various factors such as the respective ordering of associated channel measurement resources (CMR), reference signal ID values, or other associated parameters.

In addition, the UE may generate multiple CSI reports corresponding to both sTRP and NCJT CSI, and may include more than one CSI report in uplink control information (UCI) sent to a base station. In such cases, the UE may determine an ordering of CSI reports in the UCI based on corresponding channel status information reference signal (CSI-RS) resource indicator (CRI) values, CMR set ordering, CSI-RS values, among other factors. The UE may in some cases use the identified ordering of the CSI reports in the UCI to further determine various packing and omission prioritization rules for CSI reports in the UCI (e.g., in cases where the UCI payload exceeds a threshold size).

Aspects of the disclosure are initially described in the context of wireless communications systems. Aspects of the disclosure are further illustrated by and described with reference to apparatus diagrams, system diagrams, CSI packing configurations, process flows, and flowcharts that relate to details of uplink control information payload and ordering for NCJT and single TRP CSI.

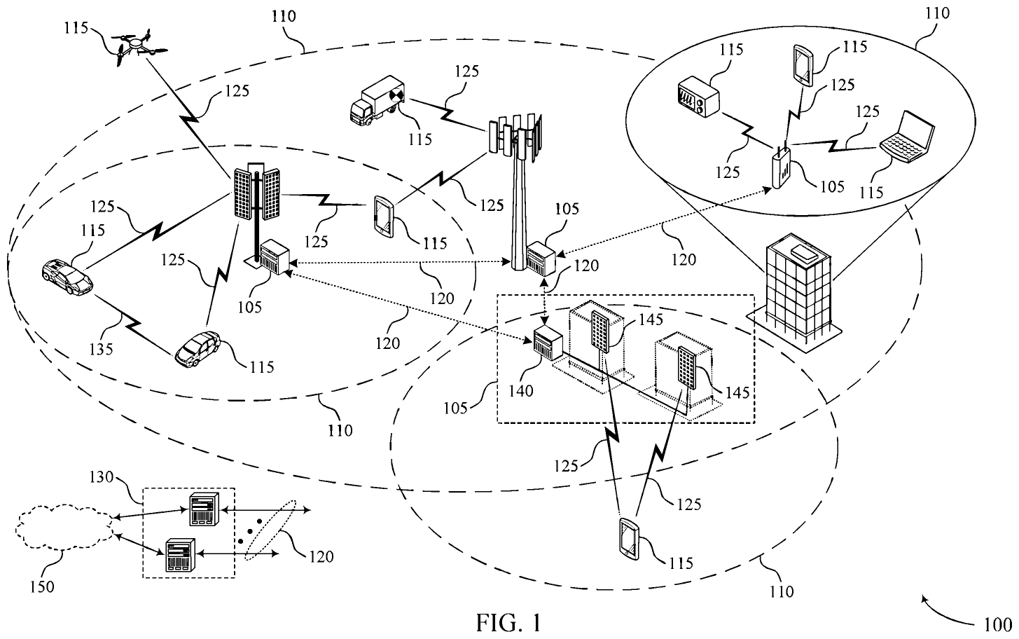

FIG. 1 illustrates an example of a wireless communications system 100 that supports details of uplink control information payload and ordering for NCJT and single TRP CSI in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of T_{S}=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some examples, a base station may send to a UE 115 a CSI report configuration that configures resources for a CSI report. The CSI report configuration may be linked to one or more resource settings, each of which may have an active resource set. For example, the CSI report configuration may be linked to a single resource setting (e.g., a resource setting for channel measurement resources (CMR)), to two resource settings (e.g., a resource setting for CMR and a resource setting for CSI-IM or non-zero-power IMR (NZP-IMR)), or to three resource settings (e.g., a resource setting for CMR, a resource setting for CSI-IM, and a resource setting for NZP-IMR). Each resource setting may have multiple resource sets, one of which may be an active resource set that the UE 115 is to use for CSI measurements. For example, a CMR resource setting may have n CMR resource sets, one of which may be configured for channel measurements. A CSI-IM resource setting may have m CSI-IM resource sets, one of which may be configured for interference measurements. And an NZP-IMR resource setting may have s NZP-IMR resource sets, one of which is configured for interference measurements. An active resource set may include one or more resources (e.g., N resources).

Each CMR in a CMR resource set may be associated with (e.g., correspond to, be configured with) a respective transmission configuration indicator (TCI) state, which may also be referred to as a transmission reception point (TRP). Thus, each CMR may be associated with a TRP.

A CMR in a CMR resource set may also be associated with (e.g., correspond to, be configured for) a single-TRP (sTRP) hypothesis. If the TRPs associated with a UE 115 support joint transmissions, a pair of CMR resources in the CMR resource set may be configured for the NCJT hypothesis associated with those TRPs. The CMRs that make up a pair of CMR resources for an NCJT hypothesis may be selected from two groups of CMR resources determined by the base station 105 (e.g., one CMR may be selected from the first group and the other CMR may be selected from the second group). So, one or more CMRs in a CMR resource set may be configured for respective sTRP hypotheses and one or more pairs of CMRs (e.g., N pairs) in the CMR resource set may be configured for respective NCJT hypotheses. A CMR in a CMR resource set may be used for both a NCJT hypothesis and an sTRP hypothesis. A hypothesis may also be referred to as a transmission hypothesis, a measurement hypothesis, a CSI hypothesis, or other suitable terminology.

A UE 115 may be configured to provide one or more CSI reports corresponding to various hypotheses. In a first CSI reporting option (referred to as Option 1), the UE 115 may be configured to report a CSI report for the NCJT hypotheses configured for the UE and X (e.g., 0, 1, 2) CSI reports for the sTRP hypothesis configured for the UE 115. A CSI report for an NCJT (referred to as an NCJT CSI report) may be a CSI report that is associated with multiple (e.g., two) CMRs, which in turn may be configured with two corresponding TCI states associated with two TRPs, respectively. In the first option (Option 1), the UE 115 may generate CSI for each NCJT hypothesis and select the best CSI to report to the base station 105. If X is equal to zero (e.g., the UE 115 is configured to provide zero CSI reports for sTRP hypotheses), the UE 115 may not generate CSI for any sTRP hypotheses. So, when X is equal to zero in Option 1, the CMRs in any of the two groups may not be used for sTRP hypotheses (rather, the CMRs may be used as pairs for NCJT hypotheses).

In a second CSI reporting option (Option 2), the UE 115 may be configured to report a single (e.g., best) CSI report for the collection of NCJT and sTRP hypotheses configured for the UE 115. In either Option 1 or Option 2, a CSI report may include a CSI-RS resource indicator (CRI) that indicates the CSI-RS resource (e.g., the CMR) to which the CSI report corresponds.

For either reporting option, the UE 115 may be configured to transmit a CSI report in uplink control information (UCI) associated with a NCJT measurement hypothesis or a sTRP hypothesis configured by single CSI reporting setting. In such cases, the UE 115 may include one or more rank indicators (RIs), PMIs, and layer indicators (LIs) per codeword. For example, the UE 115 may be configured to report two RIs, PMIs and Us in the UCI. In addition, the UE may report one channel quality information (CQI).

The UE may format the RIs, Us, PMIs, and CQI in one or more CSI reports or portions of a CSI report. For example, in some cases the UE 115 may determine a number of bits for RI and LI reporting based on a number of antenna ports (e.g., the number of CSI-RS ports or number of ports in a CMR), and a number of possible RI values configured by RRC. The reported LI my in some cases correspond to the strongest layer associated with an RI, and number of bits for reporting the LI may be based on a reported RI value.

In some examples, the UE 115 may report the RIs and CRI (which determines whether a NCJT CSI hypothesis or an sTRP hypothesis is reported) in a first portion of a CSI (e.g., CSI part 1), while reporting LIs and PMIs in a second portion of CSI (e.g., CSI part 2). In some cases, the number of bits for reporting PMI and CSI may be a function of RI and CMR such that the size or bit width of LI and PMI fields in the CSI part 2 may depend at least partially on RI value in CSI part 1. In such examples, the CSI part 1 may have constant size (e.g., irrespective of the CSI payload) while the size of CSI part 2 may be based on the corresponding payload of CSI part 1 (e.g., CSI part 1 and CSI part 2 may be separately encoded).

According to the techniques described herein, a UE 115 may improve NCJT CSI reporting by using one or more techniques for ordering two RIs PMIs, and/or LIs in an NCJT CSI report. The described techniques may allow for ordering the RIs, PMIs, and/or LIs in respective RI, PMI, and LI pairs based on associated CMR ordering, CSI-RS ID values, or using various other techniques. In addition, a UE 115 may determine an ordering of CSI reports in uplink control information (UCI) in cases where one or more sTRP CSI reports are reported in the same UCI as one NCJT CSI report. For example, the UE 115 may order the sTRP and NCJT CSI reports based on corresponding CRI values, CMR set ordering, CSI-RS values, among other factors. The UE 115 may in some cases use the identified ordering of the CSI reports in the UCI to further determine various packing and omission prioritization rules for CSI reports in the UCI (e.g., in cases where the UCI payload exceeds a threshold, and some CSI reports may be omitted from the UCI).

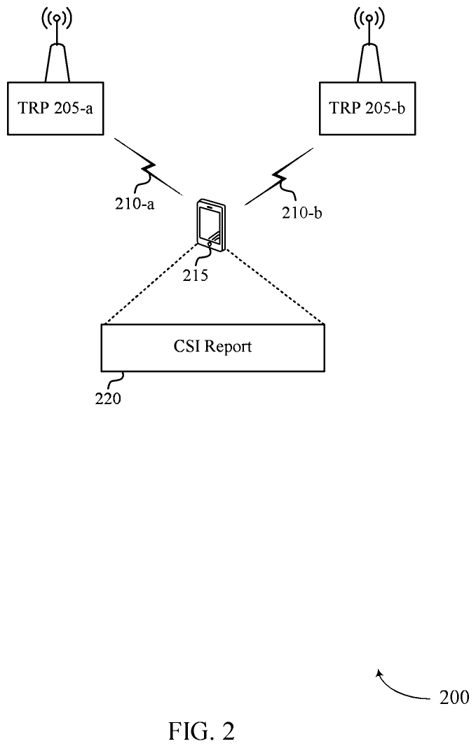

FIG. 2 illustrates an example of a wireless communications system 200 that supports details of uplink control information payload and ordering for NCJT and single TRP CSI in accordance with aspects of the present disclosure. The wireless communications system 200 may include TRP 205-a and TRP 205-b as well as a UE 215. The UE 215 may receive communications from TRP 205-a (e.g., over communication link 210-b) and TRP 205-b (e.g., over communication link 210-b). The communications from TRP 205-a and TRP 205-b may be at least partially coordinated by a base station associated with TRP 205-a and TRP 205-b.

In some examples, the ULE 215 may receive separate (non-joint, single) communications from TRP 205-a and TRP 205-b, where a separate communication is a communication from one of the TRPs 205 independent of the other TRP 205. In some examples, the UE 215 may receive joint communications from the TRPs 205, where a joint communication is a communication from both the TRPs 205. Thus, the TRPs 205 may be configured to support separate transmissions and joint transmissions. In some examples, the TRPs 205 may be configured to support coherent joint transmissions, non-coherent joint transmissions, or both. A coherent joint transmission may be a transmission in which transmission weights at the TRPs 205 are selected (based on knowledge of the channels between the UE 215 and the TRPs 205) to focus the energy at the UE 215 (e.g., in a type of non-co-located beamforming). A non-coherent joint transmission may be a transmission in which the TRPs 205 cooperate to increase the power gain of the transmission, to increase the rank that the UE 215 may be able to receive (for capacity enhancements), or to increase the diversity of the transmission (e.g., for reliability enhancements especially when the signal from one of the TRPs may be blocked due to harsh propagation environment).

To support coordinated communications in wireless communications system 200, devices may generate and exchange CSI reports. For example, the UE 215 may generate one or more CSI reports which may be NCJT CSI or sTRP CSI associated with communications between TRPs 205. The UE 215 may identify a capability to include two RIs, PMIs, and Us in the NCJT CSI, and may determine an ordering for the two RIs, PMIs, and Us based on various CSI measurement and reporting configurations.

For NCJT (e.g., mTRP or multi-TCI state) CSI associated with a pair of CMRs in a CSI report configuration, the UE 215 may report at least one of the two RIs, two PMIs, or two Us associated with the two CMRs as part of the CSI report. In some examples, the UE 215 may determine the order of the two RIs, PMIs, or Us in the CSI report payload based on the order of the two CMRs in the CMR pair. For example, the pair of CMRs may be configured to the UE 215 for an NCJT hypothesis, and the UE may determine an explicit or implicit ordering of the CMRs in the CMR pair.

In some other cases, the UE 215 may identify one or more CMR groups configured within a CSI-RS resource set in the CSI report configuration. In such cases, the UE 215 may determine that the first RI, PMI, or LI in the set of RIs, PMIs, or Us is associated with the CMR in a first CMR group and the second RI, PMI, or LI in the set of RIs, PMIs, or LIs is associated with the CMR in a second CMR group. In some other cases, the ordering of the two RIs, PMIs, or LIs may be based on the order of appearance of the two CMRs in the CSI-RS resource set (e.g., the RI, LI, or PMI associated with a first CMR which appears first in the CSI-RS resource set will be ordered first in the set of two RIs, LIs, or PMIs).

In some other examples, the UE 215 may determine the ordering of the two RIs, PMIs, or LIs may be based on a relative value of the CSI-RS resource ID of the two CMRs (e.g., the first RI, LI, or PMI may be associated with the CMR that has a smaller CSI-RS resource ID).

The UE 215 may generate multiple CSI reports based on communications with TRPs 205. For example, in some cases, the UE 215 may generate three CSI reports (e.g., when X=2 is configured), and the UE 215 may generate two sTRP CSI reports and one NCJT CSI report. In such cases, the UE 215 may determine an ordering of the CSI reports it includes in UCI transmission. For example, when the UE 215 is configured to report two CSI reports associated with an sTRP measurement hypotheses and one CSI report associated with an NCJT measurement hypothesis in a CSI report configuration (e.g., three CSIs total are reported for the CSI report configuration), the order of the three CSIs in the UCI is determined based on various factors. For example, the UE 215 may identify the ordering based on an ordering between sTRP CSIs versus the NCJT CSI (e.g., the two single-TRP CSIs may be placed first in the UCI, or the NCJT CSI may be placed first in the CSI based on the identified ordering). Accordingly, for the two CSIs corresponding to the sTRP hypotheses, the order of the two sTRP CSIs in the UCI may be based on a corresponding CSI-RS resource indicator (CRI) values for the sTRP CSIs (e.g., the sTRP associated with a lower CRI value is placed first in the UCI).

In some other examples, the ordering of the two sTRP CSIs in the UCI may be based on the CMR group to which the corresponding CSI belongs (e.g., the CSI corresponding to the first CMR group may be placed first in the UCI). In some other examples, the UE 215 may determine the ordering of the two sTRP CSIs based on the corresponding CSI-RS resource ID (e.g., the CSI corresponding to the CMR with a lower CSI-RS resource ID may be placed first in the UCI). In some other examples, the UE 215 may determine the ordering of the two sTRP CSIs in the UCI based on the order of the appearance of the corresponding CMR in the CSI-RS resource set (e.g., the CSI whose associated CMR appears first in the CSI-RS resource set may be placed first in the UCI ordering).

Additionally or alternatively, the UE 215 may use the ordering of the CSI reports to determine a CSI omission rule for CSIs included in the UCI. For example, when a second portion of CSI (e.g., CSI part 2) is multiplexed on a physical uplink shared channel (PUSCH), the ordering of the CSI reports determines which CSIs that the UE 215 may omit first from the UCI in cases that PUSCH resources are not enough to support the payload of the UCI. Further, the UE 215 may use the identified priority of the CSI reports within a given CSI report configuration for determining one or more UCI multiplexing rules on a physical uplink control channel (PUCCH) in the case of multiple overlapping UCIs.

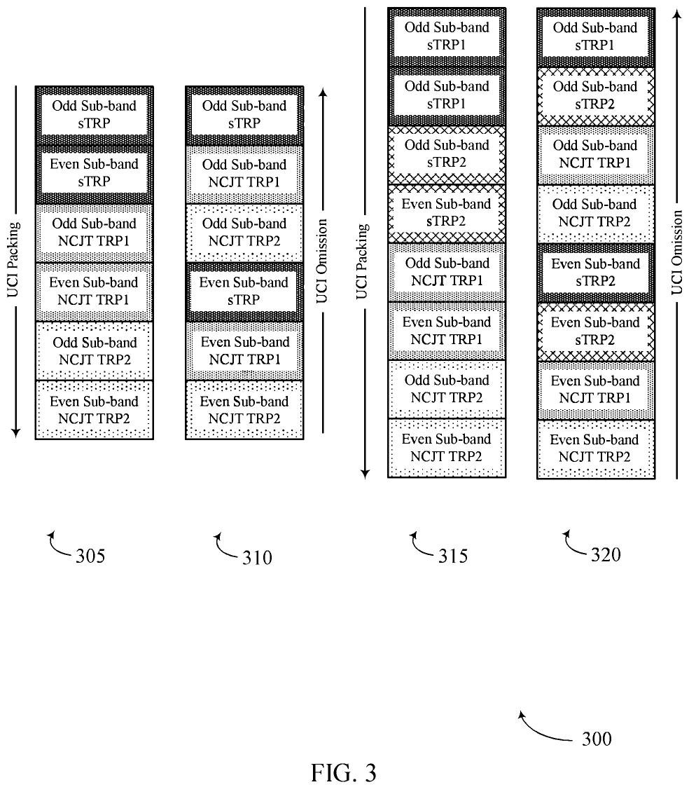

FIG. 3 illustrates an example of different UCI packing configurations 300 that supports details of uplink control information payload and ordering for NCJT and single TRP CSI in accordance with aspects of the present disclosure. The UCI packing configurations may be implemented by a UE, such as a UE 115 or 215 described with reference to FIGS. 1 and 2.

In some examples, a UE may be configured to report CSI in two parts (e.g., part 1 CSI and part 2 CSI) on PUSCH. In such examples, the UE may omit a portion of the Part 2 CSI in cases where the UCI payload exceeds a threshold payload size. The UE may determine omission priority of CSI reports of the part 2 CSI based on a number of priority rules. For example, for each CSI report, a wide-band part of all reports are aggregated together and packed first and omitted last. The sub-band part may be divided into two parts, such that the first part is odd sub-band CSI (e.g., if Type I), and the second part is even sub-band CSI (e.g., if type I). Accordingly, the first part (e.g., odd-sub-band) may be packed prior to, and omitted later than, than the second part (e.g., even sub-band).

UCI packing configurations 305 and 310 illustrate example UCI packing configurations that a UE may use in cases where X=1 (e.g., one sTRP CSI and one NCJT CSI). In UCI packing configuration 305, the UE may pack CSI reports based on an ordering of the CSI hypothesis, and then based on the odd/even sub-band priority. For example, the UE may pack the odd sub-band sTRP CSI, followed by the even sub-band sTRP CSI, followed by the odd sub-band NCJT CSI of a first TRP (e.g., where the first TRP corresponds to the PMI of the first CMR of the CMR pair associated with the NCJT CSI), followed by the even sub-band of the NCJT CSI for the first TRP, followed by the odd sub-band NCJT CSI of a second TRP (e.g., where the second TRP corresponds to the PMI of the second CMR of the CMR pair associated with the NCJT CSI), followed by the even sub-band of the NCJT CSI for the second TRP. In UCI packing configuration 310, the UE may pack CSI reports based on an the odd/even sub-band priority, then based on the order of the CSI hypotheses. For example, the UE may pack the odd sub-band sTRP CSI, followed by the odd sub-band NCJT CSI for the first and second TRPs. Then the UE may pack the even sub-band sTRP CSI, followed by the even sub-bands for the NCJT CSI for the first and second TRPs.

UCI packing configurations 315 and 320 illustrate example UCI packing configurations that a UE may use in cases where X=2 (e.g., two sTRP CSI and one NCJT CSI). In UCI packing configuration 315, the UE may pack CSI reports based on an ordering of the CSI hypothesis, and then based on the odd/even sub-band priority. For example, the UE may pack the odd sub-band of the first sTRP CSI (for a first TRP), followed by the even sub-band of the first sTRP CSI (for the first TRP), followed by the odd sub-band of the second sTRP CSI (for a second TRP), followed by the even sub-band of the second sTRP CSI (for the second TRP), followed by the odd sub-band of the NCJT CSI for a first TRP, followed by the even sub-band of the NCJT CSI for the first TRP (e.g., where the first TRP corresponds to the PMI of the first CMR of the CMR pair associated with the NCJT CSI), followed by the odd sub-band of the NCJT CSI for a second TRP (e.g., where the second TRP corresponds to the PMI of the second CMR of the CMR pair associated with the NCJT CSI), followed by the even sub-band of the NCJT CSI for the second TRP. In UCI packing configuration 320, the UE may pack CSI reports based on an the odd/even sub-band priority, then based on the order of the CSI hypotheses. For example, the UE may pack the odd sub-bands of the first and second sTRP CSIs (for the first and second TRPs), followed by the odd sub-band of the NCJT CSI for the first and second TRPs. Then the UE may pack the even sub-bands of the first and second sTRP CSIs (for the first and second TRPs), followed by the even sub-bands of the NCJT CSI for the first and second TRPs.

In the example UCI packing configurations 300, the UE may begin UCI packing starting with the odd sub-band of the sTRP CSI, and may begin CSI omission from the even sub-band of the NCJT CSI associated with the second TRP.

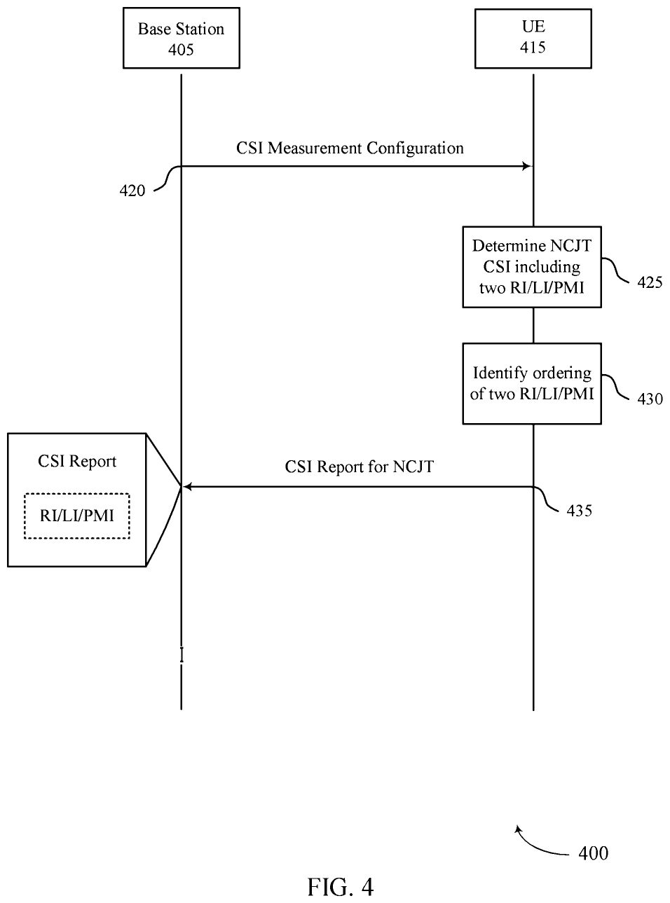

FIG. 4 illustrates an example of a process flow 400 that supports details of uplink control information payload and ordering for NCJT and single TRP CSI in accordance with aspects of the present disclosure. In some examples, the process flow 400 may be related to aspects of the wireless communications system 100 or the wireless communications system 200. For example, the process flow 400 may be implemented by a base station 405 and a UE 415, which may be examples of a base station or a UE as described herein. The process flow 400 may allow the UE 315 to determine an ordering for two RIs, Us, and PMIs in an NCJT CSI. In some cases, alternative examples of the following process flow may be implemented, where some steps are performed in a different order than described or are not performed at all. In some cases, steps may include additional features not mentioned below, or further steps may be added. In addition, while process flow 400 shows processes between a single base station and UE, it should be understood that these processes may occur between any number of network devices.

At 420, the base station 405 may transmit, and the UE 415 may receive, an indication of a first CMR and a second CMR in a CMR set, both the first and second CMRs configured for measuring CSI-RSs. In some cases, the first CMR may be associated with a first TCI state and the second CMR may be associated with a second TCI state.

At 425, the UE 415 may determine CSI for a joint transmission hypothesis to be included in a CSI report, the CSI report to include two RIs, two PMIs, two Us, or combinations thereof. In some examples, each indicator of each pair of indicators may be associated with a respective one of either the first CMR or the second CMR.

At 430, the UE 415 may identify, for inclusion in the CSI report, an ordering of each indicator (e.g., each RI, PMI, and LI) in at least one of the pairs of indicators associated with the first and second CMRs. In some examples, the UE 415 may determine the ordering based on a CMR ordering of the first CMR and the second CMR. In some cases, the UE 415 may receive (e.g., from the base station 405) an implicit or an explicit indication of the CMR ordering. In some cases, the UE 415 may transmit, to the base station 405, a capability to transmit the CSI report for the joint transmission hypothesis which includes the two RIs, Us, and PMIs, or a combination thereof.

In some other examples, the UE 415 may determine the ordering of each indicator by associating a first indicator of the at least one of the pairs of indicators with the first CMR based on the first CMR being associated with a first CMR group. The UE 415 may associate a second indicator of the at least one of the pairs of indicators with the second CMR based on the second CMR being associated with a second CMR group. In such cases, CMR set includes the first CMR and the second CMR.

In some other examples, the UE 415 may determine the ordering of each indicator in the at least one of the pairs of indicators based on an order of appearance of the first CMR and the second CMR in the CMR set.

In some cases, the UE 415 identify a first CRI associated with the first CMR and a second CRI associated with the second CMR, and the UE 415 may determine the ordering of each indicator in the at least one of the pairs of indicators based on respective values of the first CRI and the second CRI. For example, the CRI associated with the first indicator may have a lesser value than the CRI associated with the second indicator.

At 435, the UE may transmit the NCJT CSI report that includes the identified ordering of the RI, PMI, and LI.

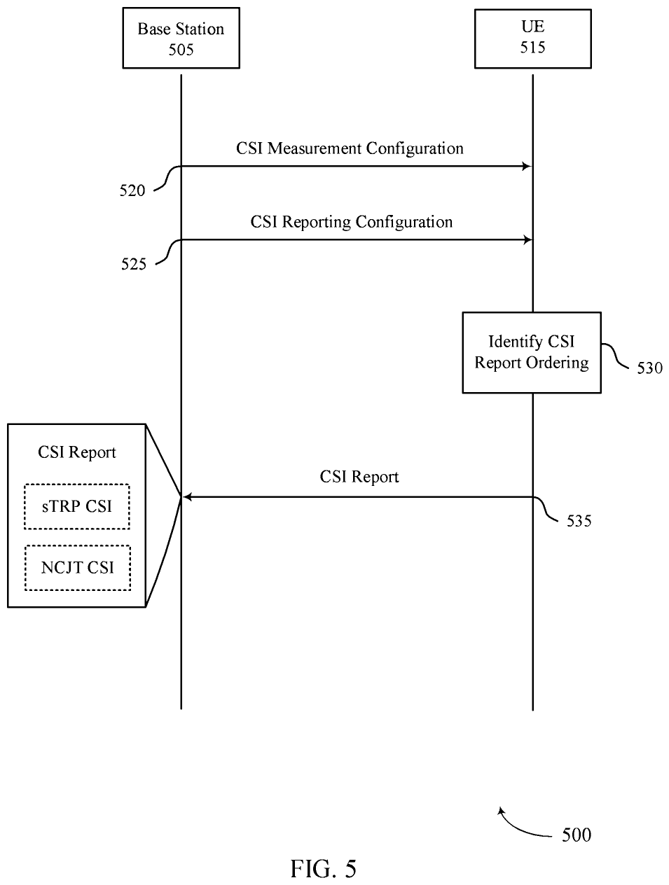

FIG. 5 illustrates an example of a process flow 500 that supports details of uplink control information payload and ordering for NCJT and single TRP CSI in accordance with aspects of the present disclosure. In some examples, the process flow 500 may be related to aspects of the wireless communications system 100 or the wireless communications system 200. For example, the process flow 500 may be implemented by a base station 505 and a UE 515, which may be examples of a base station or a UE as described herein. The process flow 500 may allow the UE 515 to determine an ordering rule for multiple sTRP and NCJT CSI reports in UCI. In some cases, alternative examples of the following process flow may be implemented, where some steps are performed in a different order than described or are not performed at all. In some cases, steps may include additional features not mentioned below, or further steps may be added. In addition, while process flow 500 shows processes between a single base station and UE, it should be understood that these processes may occur between any number of network devices.

At 520, the base station 505 may transmit, and the UE 515 may receive, an indication of a first CMR and a second CMR, each configured for measuring CSI-RSs, the first CMR associated with a first TCI state and the second CMR associated with a second TCI state.

At 525, the base station 505 may transmit, and the UE 515 may receive, a configuration for measuring CSI-RSs for a first CSI report that includes a first single transmission hypothesis associated with the CMR, a second CSI report that includes a second single transmission hypothesis associated with the second CMR, and a third CSI report that includes a joint transmission hypothesis associated with both a third CMR and a fourth CMR.

At 530, the UE 515 may identify, for inclusion in UCI, an ordering of the first CSI report, the second CSI report, and the third CSI report based on association of respective channel CSI with either single transmission or joint transmission hypotheses.

In some examples, the UE 515 may allocate the first CSI report and the second CSI report to a first portion of the UCI or allocating the third CSI report to the first portion of the UCI. In some cases, the UE 515 may order the first CSI report and the second CSI report based on corresponding CRI values. In such cases, the CSI report corresponding to a lowest CRI value is first in the ordering, or the ordering may be based on corresponding CMR groups for the CSI reports, and the CSI report associated with the first CMR group is first in the ordering.

In some other examples, the UE 515 may order the first CSI report and the second CSI report based on corresponding CSI reference signal resource ID values, and the CSI report corresponding to a lowest CSI reference signal resource ID value may be first in the ordering.

In some other examples, the UE 515 may order the first CSI report and the second CSI report based on an order of appearance of corresponding CMRs for the first CSI report and the second CSI report in a CSI resource set, and the CMR appearing first in the CSI resource set is first in the ordering.

In some other examples, the UE 515 may order the CSI reports first based on an order of the respective transmission hypothesis in the UCI, and second based on alternating sub-bands of the CSI reports. In some other cases, the UE 515 may order the CSI reports first based on alternating sub-bands of the CSI reports and second based on an order of the respective transmission hypothesis in the UCI.

In some examples, the UE 515 may identify a CSI report omission rule based on the ordering of the CSI reports. In some cases, the UE 515 may apply the CSI report omission rule for a second portion of the CSI reports multiplexed on uplink resources for transmission of the UCI. In some cases, the UCI overlaps with at least one other UCI, and the UCI is multiplexed based on the identified overlap.

At 535, the UE 515 may transmit, and the base station 505 may receive, the UCI which includes the ordering of CSI.

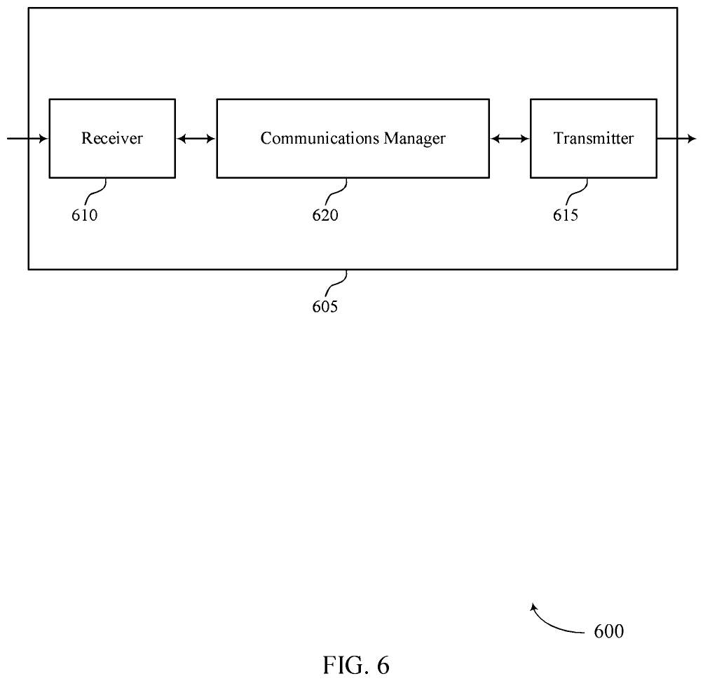

FIG. 6 shows a block diagram 600 of a device 605 that supports details of uplink control information payload and ordering for NCJT and single TRP CSI in accordance with aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to details of uplink control information payload and ordering for NCJT and single TRP CSI). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to details of uplink control information payload and ordering for NCJT and single TRP CSI). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of details of uplink control information payload and ordering for NCJT and single TRP CSI as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 620 may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communications at a UE in accordance with examples as disclosed herein. For example, the communications manager 620 may be configured as or otherwise support a means for receiving an indication of a first channel measurement resource and a second channel measurement resource in a channel measurement resource set, each configured for measuring channel state information reference signals, the first channel measurement resource associated with a first transmission configuration indicator state and the second channel measurement resource associated with a second transmission configuration indicator state. The communications manager 620 may be configured as or otherwise support a means for determining channel state information for a joint transmission hypothesis to be included in a channel state information report, the channel state information including two rank indicators, two precoding matrix indicators, two layer indicators, or combinations thereof, each indicator of each pair of indicators associated with a respective one of either the first channel measurement resource or the second channel measurement resource. The communications manager 620 may be configured as or otherwise support a means for identifying, for inclusion in the channel state information report, an ordering of each indicator in at least one of the pairs of indicators associated with the first channel measurement resource and the second channel measurement resource. The communications manager 620 may be configured as or otherwise support a means for transmitting, to a base station, the channel state information report that includes the ordering.

Additionally or alternatively, the communications manager 620 may support wireless communications at a UE in accordance with examples as disclosed herein. For example, the communications manager 620 may be configured as or otherwise support a means for receiving an indication of a first channel measurement resource and a second channel measurement resource, each configured for measuring channel state information reference signals, the first channel measurement resource associated with a first transmission configuration indicator state and the second channel measurement resource associated with a second transmission configuration indicator state. The communications manager 620 may be configured as or otherwise support a means for receiving a configuration for measuring channel state information reference signals for a first channel state information report that includes a first single transmission hypothesis associated with the first channel measurement resource, a second channel state information report that includes a second single transmission hypothesis associated with the second channel measurement resource, and a third channel state information report that includes a joint transmission hypothesis associated with both a third channel measurement resource and a fourth channel measurement resource. The communications manager 620 may be configured as or otherwise support a means for identifying, for inclusion in uplink control information, an ordering of the first channel state information report, the second channel state information report, and the third channel state information report based on association of respective channel state information with either single transmission or joint transmission hypotheses. The communications manager 620 may be configured as or otherwise support a means for transmitting, to a base station, the uplink control information that includes the ordering.

By including or configuring the communications manager 620 in accordance with examples as described herein, the device 605 (e.g., a processor controlling or otherwise coupled to the receiver 610, the transmitter 615, the communications manager 620, or a combination thereof) may support techniques for more efficient utilization of communication resources, more efficient CSI reporting and prioritization, and more effective prioritization of RI, LI, and PMI within a CSI report.

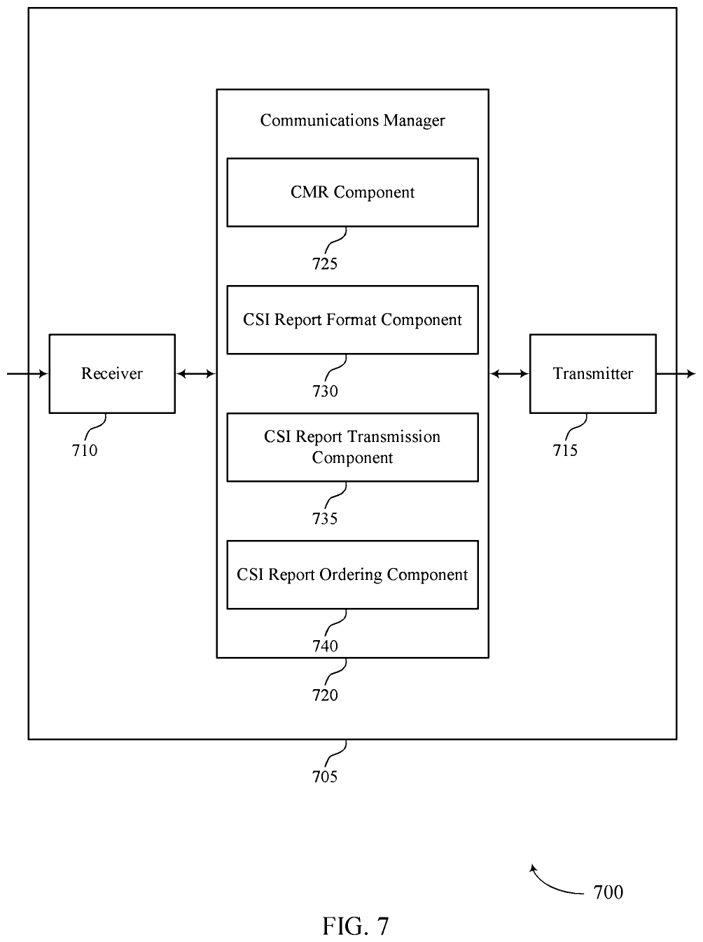

FIG. 7 shows a block diagram 700 of a device 705 that supports details of uplink control information payload and ordering for NCJT and single TRP CSI in accordance with aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to details of uplink control information payload and ordering for NCJT and single TRP CSI). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to details of uplink control information payload and ordering for NCJT and single TRP CSI). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of details of uplink control information payload and ordering for NCJT and single TRP CSI as described herein. For example, the communications manager 720 may include an CMR component 725, a CSI report format component 730, a CSI report transmission component 735, a CSI report ordering component 740, or any combination thereof. The communications manager 720 may be an example of aspects of a communications manager 620 as described herein. In some examples, the communications manager 720, or various components thereof, may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communications at a UE in accordance with examples as disclosed herein. The CMR component 725 may be configured as or otherwise support a means for receiving an indication of a first channel measurement resource and a second channel measurement resource in a channel measurement resource set, each configured for measuring channel state information reference signals, the first channel measurement resource associated with a first transmission configuration indicator state and the second channel measurement resource associated with a second transmission configuration indicator state. The CSI report format component 730 may be configured as or otherwise support a means for determining channel state information for a joint transmission hypothesis to be included in a channel state information report, the channel state information including two rank indicators, two precoding matrix indicators, two layer indicators, or combinations thereof, each indicator of each pair of indicators associated with a respective one of either the first channel measurement resource or the second channel measurement resource. The CSI report format component 730 may be configured as or otherwise support a means for identifying, for inclusion in the channel state information report, an ordering of each indicator in at least one of the pairs of indicators associated with the first channel measurement resource and the second channel measurement resource. The CSI report transmission component 735 may be configured as or otherwise support a means for transmitting, to a base station, the channel state information report that includes the ordering.

Additionally or alternatively, the communications manager 720 may support wireless communications at a UE in accordance with examples as disclosed herein. The CMR component 725 may be configured as or otherwise support a means for receiving an indication of a first channel measurement resource and a second channel measurement resource, each configured for measuring channel state information reference signals, the first channel measurement resource associated with a first transmission configuration indicator state and the second channel measurement resource associated with a second transmission configuration indicator state. The CSI report ordering component 740 may be configured as or otherwise support a means for receiving a configuration for measuring channel state information reference signals for a first channel state information report that includes a first single transmission hypothesis associated with the first channel measurement resource, a second channel state information report that includes a second single transmission hypothesis associated with the second channel measurement resource, and a third channel state information report that includes a joint transmission hypothesis associated with both a third channel measurement resource and a fourth channel measurement resource. The CSI report format component 730 may be configured as or otherwise support a means for identifying, for inclusion in uplink control information, an ordering of the first channel state information report, the second channel state information report, and the third channel state information report based on association of respective channel state information with either single transmission or joint transmission hypotheses. The CSI report transmission component 735 may be configured as or otherwise support a means for transmitting, to a base station, the uplink control information that includes the ordering.

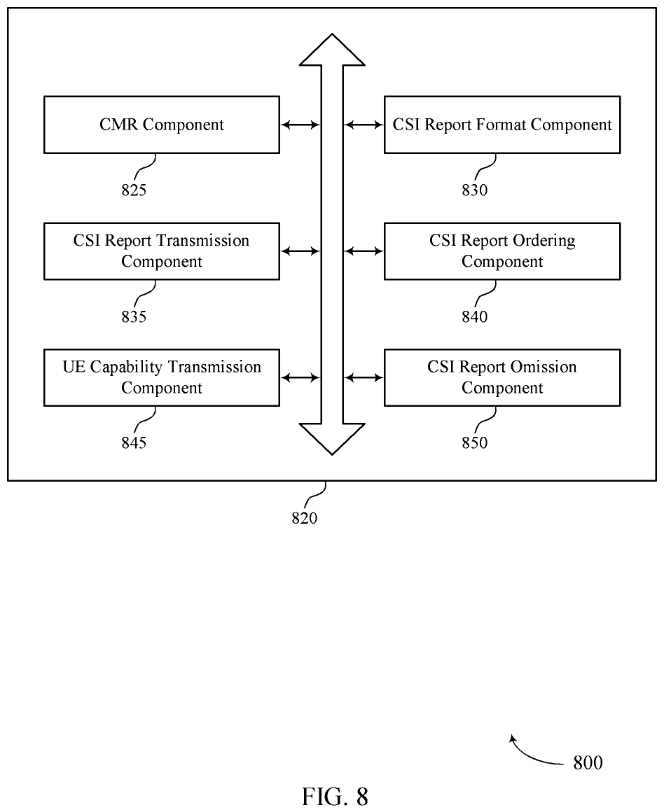

FIG. 8 shows a block diagram 800 of a communications manager 820 that supports details of uplink control information payload and ordering for NCJT and single TRP CSI in accordance with aspects of the present disclosure. The communications manager 820 may be an example of aspects of a communications manager 620, a communications manager 720, or both, as described herein. The communications manager 820, or various components thereof, may be an example of means for performing various aspects of details of uplink control information payload and ordering for NCJT and single TRP CSI as described herein. For example, the communications manager 820 may include an CMR component 825, a CSI report format component 830, a CSI report transmission component 835, a CSI report ordering component 840, a UE capability transmission component 845, a CSI report omission component 850, or any combination thereof. Each of these components may communicate, directly or indirectly, with one another (e.g., via one or more buses).

The communications manager 820 may support wireless communications at a UE in accordance with examples as disclosed herein. The CMR component 825 may be configured as or otherwise support a means for receiving an indication of a first channel measurement resource and a second channel measurement resource in a channel measurement resource set, each configured for measuring channel state information reference signals, the first channel measurement resource associated with a first transmission configuration indicator state and the second channel measurement resource associated with a second transmission configuration indicator state. The CSI report format component 830 may be configured as or otherwise support a means for determining channel state information for a joint transmission hypothesis to be included in a channel state information report, the channel state information including two rank indicators, two precoding matrix indicators, two layer indicators, or combinations thereof, each indicator of each pair of indicators associated with a respective one of either the first channel measurement resource or the second channel measurement resource. In some examples, the CSI report format component 830 may be configured as or otherwise support a means for identifying, for inclusion in the channel state information report, an ordering of each indicator in at least one of the pairs of indicators associated with the first channel measurement resource and the second channel measurement resource. The CSI report transmission component 835 may be configured as or otherwise support a means for transmitting, to a base station, the channel state information report that includes the ordering.

In some examples, to support identifying the ordering of each indicator in at least one of the pairs of indicators, the CSI report format component 830 may be configured as or otherwise support a means for determining the ordering of each indicator in the at least one of the pairs of indicators based on a channel measurement resource ordering of the first channel measurement resource and the second channel measurement resource.

In some examples, the CSI report format component 830 may be configured as or otherwise support a means for receiving an implicit indication or an explicit indication of the channel measurement resource ordering.

In some examples, to support identifying the ordering of each indicator in at least one of the pairs of indicators, the CSI report format component 830 may be configured as or otherwise support a means for determining the ordering of each indicator in the at least one of the pairs of indicators by associating a first indicator of the at least one of the pairs of indicators with the first channel measurement resource based on the first channel measurement resource being associated with a first channel measurement resource group and a second indicator of the at least one of the pairs of indicators with the second channel measurement resource based on the second channel measurement resource being associated with a second channel measurement resource group, the first channel measurement resource group and the second channel measurement resource group including the channel measurement resource set.

In some examples, to support identifying the ordering of each indicator in at least one of the pairs of indicators, the CSI report format component 830 may be configured as or otherwise support a means for determining the ordering of each indicator in the at least one of the pairs of indicators based on an order of appearance of the first channel measurement resource and the second channel measurement resource in the channel measurement resource set.

In some examples, to support identifying the ordering of each indicator in at least one of the pairs of indicators, the CMR component 825 may be configured as or otherwise support a means for identifying a first channel state information reference signal resource identifier associated with the first channel measurement resource and a second channel state information reference signal resource identifier associated with the second channel measurement resource. In some examples, to support identifying the ordering of each indicator in at least one of the pairs of indicators, the CSI report format component 830 may be configured as or otherwise support a means for determining the ordering of each indicator in the at least one of the pairs of indicators based on respective values of the first channel state information reference signal resource identifier and the second channel state information reference signal resource identifier.

In some examples, the channel measurement resource associated with a first indicator has a lesser value than the channel measurement resource associated with a second indicator.

In some examples, the UE capability transmission component 845 may be configured as or otherwise support a means for transmitting, to the base station, a capability of the UE to transmit the channel state information report for the joint transmission hypothesis including the two rank indicators, two precoding matrix indicators, two layer indicators, or a combination thereof.

Additionally or alternatively, the communications manager 820 may support wireless communications at a UE in accordance with examples as disclosed herein. In some examples, the CMR component 825 may be configured as or otherwise support a means for receiving an indication of a first channel measurement resource and a second channel measurement resource, each configured for measuring channel state information reference signals, the first channel measurement resource associated with a first transmission configuration indicator state and the second channel measurement resource associated with a second transmission configuration indicator state. The CSI report ordering component 840 may be configured as or otherwise support a means for receiving a configuration for measuring channel state information reference signals for a first channel state information report that includes a first single transmission hypothesis associated with the first channel measurement resource, a second channel state information report that includes a second single transmission hypothesis associated with the second channel measurement resource, and a third channel state information report that includes a joint transmission hypothesis associated with both a third channel measurement resource and a fourth channel measurement resource. In some examples, the CSI report format component 830 may be configured as or otherwise support a means for identifying, for inclusion in uplink control information, an ordering of the first channel state information report, the second channel state information report, and the third channel state information report based on association of respective channel state information with either single transmission or joint transmission hypotheses. In some examples, the CSI report transmission component 835 may be configured as or otherwise support a means for transmitting, to a base station, the uplink control information that includes the ordering.

In some examples, to support identifying of the ordering of the first channel state information report, the second channel state information report, and the third channel state information report, the CSI report ordering component 840 may be configured as or otherwise support a means for allocating the first channel state information report and the second channel state information report to a first portion of the uplink control information or allocating the third channel state information report to the first portion of the uplink control information.

In some examples, the CSI report ordering component 840 may be configured as or otherwise support a means for ordering the first channel state information report and the second channel state information report based on corresponding channel state information reference signal resource indicator values, where the channel state information report corresponding to a lowest channel state information reference signal resource indicator value is first in the ordering.

In some examples, the CSI report ordering component 840 may be configured as or otherwise support a means for ordering the first channel state information report and the second channel state information report based on corresponding channel measurement resource groups for the channel state information reports, where the channel state information report associated with the first channel measurement resource group is first in the ordering.

In some examples, the CSI report ordering component 840 may be configured as or otherwise support a means for ordering the first channel state information report and the second channel state information report based on corresponding channel state information reference signal resource ID values, where the channel state information report corresponding to a lowest channel state information reference signal resource ID value is first in the ordering.

In some examples, the CSI report ordering component 840 may be configured as or otherwise support a means for ordering the first channel state information report and the second channel state information report based on an order of appearance of corresponding channel measurement resources for the first channel state information report and the second channel state information report in a channel state information resource set, where the channel measurement resource appearing first in the channel state information resource set is first in the ordering.

In some examples, the CSI report omission component 850 may be configured as or otherwise support a means for identifying a channel state information report omission rule based on the ordering, where the channel state information report omission rule is applied for a second portion of the channel state information reports multiplexed on uplink resources for transmission of the uplink control information.

In some examples, the uplink control information overlaps with at least one other uplink control information, the uplink control information multiplexed in accordance with the ordering of the first channel state information report, the second channel state information report, and the third channel state information report.

In some examples, to support ordering, the CSI report ordering component 840 may be configured as or otherwise support a means for ordering the channel state information reports first based on an order of the respective transmission hypothesis in the uplink control information, and second based on alternating sub-bands of the channel state information reports.

In some examples, to support ordering, the CSI report ordering component 840 may be configured as or otherwise support a means for ordering the channel state information reports first based on alternating sub-bands of the channel state information reports and second based on an order of the respective transmission hypothesis in the uplink control information.

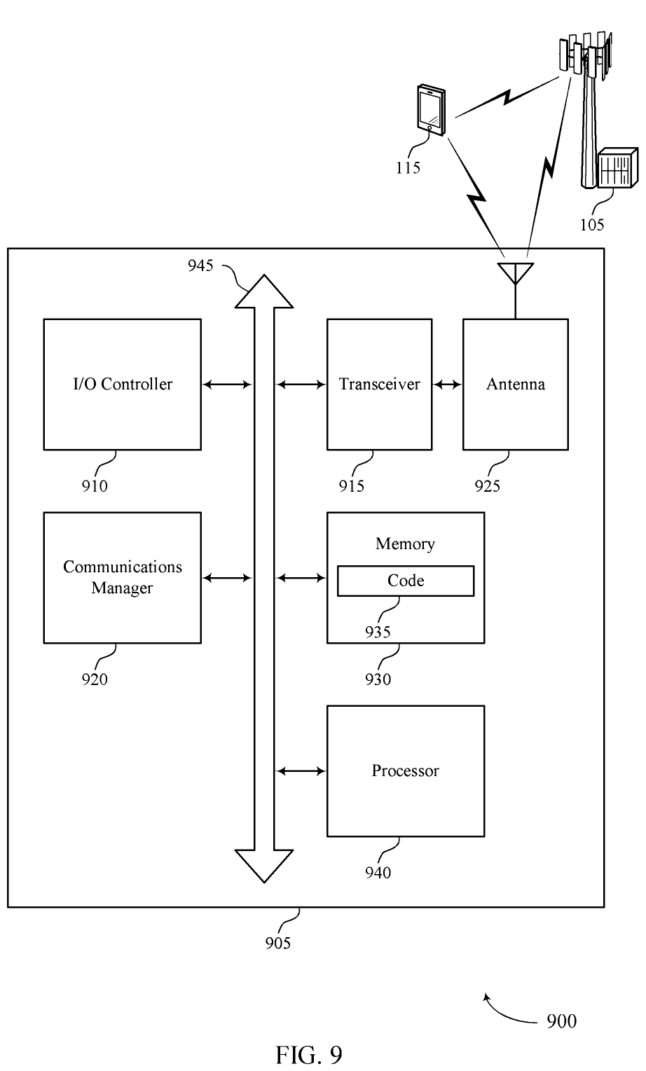

FIG. 9 shows a diagram of a system 900 including a device 905 that supports details of uplink control information payload and ordering for NCJT and single TRP CSI in accordance with aspects of the present disclosure. The device 905 may be an example of or include the components of a device 605, a device 705, or a UE 115 as described herein. The device 905 may communicate wirelessly with one or more base stations 105, UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting details of uplink control information payload and ordering for NCJT and single TRP CSI). For example, the device 905 or a component of the device 905 may include a processor 940 and memory 930 coupled to the processor 940, the processor 940 and memory 930 configured to perform various functions described herein.

The communications manager 920 may support wireless communications at a UE in accordance with examples as disclosed herein. For example, the communications manager 920 may be configured as or otherwise support a means for receiving an indication of a first channel measurement resource and a second channel measurement resource in a channel measurement resource set, each configured for measuring channel state information reference signals, the first channel measurement resource associated with a first transmission configuration indicator state and the second channel measurement resource associated with a second transmission configuration indicator state. The communications manager 920 may be configured as or otherwise support a means for determining channel state information for a joint transmission hypothesis to be included in a channel state information report, the channel state information including two rank indicators, two precoding matrix indicators, two layer indicators, or combinations thereof, each indicator of each pair of indicators associated with a respective one of either the first channel measurement resource or the second channel measurement resource. The communications manager 920 may be configured as or otherwise support a means for identifying, for inclusion in the channel state information report, an ordering of each indicator in at least one of the pairs of indicators associated with the first channel measurement resource and the second channel measurement resource. The communications manager 920 may be configured as or otherwise support a means for transmitting, to a base station, the channel state information report that includes the ordering.

Additionally or alternatively, the communications manager 920 may support wireless communications at a UE in accordance with examples as disclosed herein. For example, the communications manager 920 may be configured as or otherwise support a means for receiving an indication of a first channel measurement resource and a second channel measurement resource, each configured for measuring channel state information reference signals, the first channel measurement resource associated with a first transmission configuration indicator state and the second channel measurement resource associated with a second transmission configuration indicator state. The communications manager 920 may be configured as or otherwise support a means for receiving a configuration for measuring channel state information reference signals for a first channel state information report that includes a first single transmission hypothesis associated with the first channel measurement resource, a second channel state information report that includes a second single transmission hypothesis associated with the second channel measurement resource, and a third channel state information report that includes a joint transmission hypothesis associated with both a third channel measurement resource and a fourth channel measurement resource. The communications manager 920 may be configured as or otherwise support a means for identifying, for inclusion in uplink control information, an ordering of the first channel state information report, the second channel state information report, and the third channel state information report based on association of respective channel state information with either single transmission or joint transmission hypotheses. The communications manager 920 may be configured as or otherwise support a means for transmitting, to a base station, the uplink control information that includes the ordering.

By including or configuring the communications manager 920 in accordance with examples as described herein, the device 905 may support techniques for improved communication reliability, more efficient utilization of communication resources, improved coordination between devices, and more efficient prioritization of channel information.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of details of uplink control information payload and ordering for NCJT and single TRP CSI as described herein, or the processor 940 and the memory 930 may be otherwise configured to perform or support such operations.

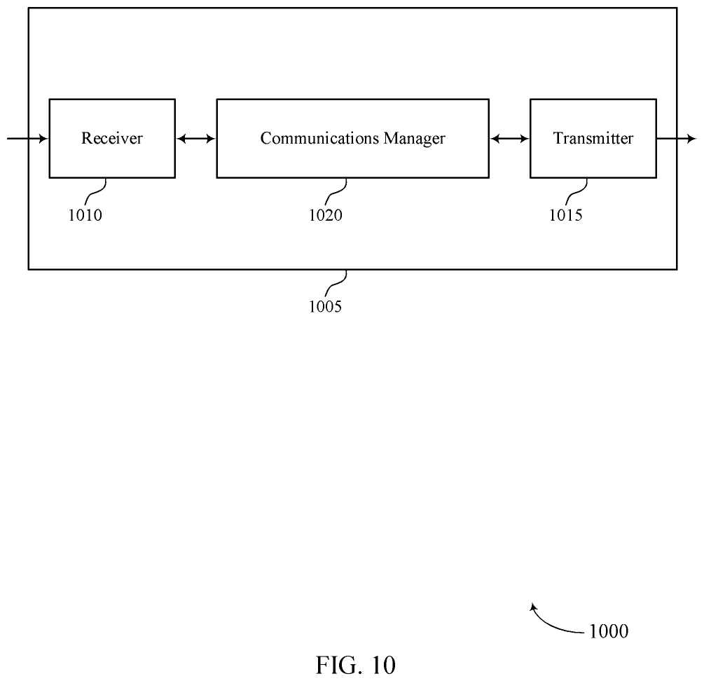

FIG. 10 shows a block diagram 1000 of a device 1005 that supports details of uplink control information payload and ordering for NCJT and single TRP CSI in accordance with aspects of the present disclosure. The device 1005 may be an example of aspects of a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to details of uplink control information payload and ordering for NCJT and single TRP CSI). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to details of uplink control information payload and ordering for NCJT and single TRP CSI). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of details of uplink control information payload and ordering for NCJT and single TRP CSI as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1020 may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communications at a base station in accordance with examples as disclosed herein. For example, the communications manager 1020 may be configured as or otherwise support a means for transmitting, to a UE, an indication of a first channel measurement resource and a second channel measurement resource in a channel measurement resource set, each configured for measuring channel state information reference signals by the UE, the first channel measurement resource associated with a first transmission configuration indicator state and the second channel measurement resource associated with a second transmission configuration indicator state. The communications manager 1020 may be configured as or otherwise support a means for receiving, from the UE, a channel state information report including channel state information for a joint transmission hypothesis, the channel state information including two rank indicators, two precoding matrix indicators, two layer indicators, or combinations thereof, each indicator of each pair of indicators associated with a respective one of either the first channel measurement resource or the second channel measurement resource, and an ordering of each indicator in at least one of the pairs of indicators associated with the first channel measurement resource and the second channel measurement resource.

Additionally or alternatively, the communications manager 1020 may support wireless communications at a base station in accordance with examples as disclosed herein. For example, the communications manager 1020 may be configured as or otherwise support a means for transmitting, to a UE, an indication of a first channel measurement resource and a second channel measurement resource, each configured for measuring channel state information reference signals at the UE, the first channel measurement resource associated with a first transmission configuration indicator state and the second channel measurement resource associated with a second transmission configuration indicator state. The communications manager 1020 may be configured as or otherwise support a means for transmitting, to the UE, a configuration for measuring channel state information reference signals for a first channel state information report that includes a first single transmission hypothesis associated with the first channel measurement resource, a second channel state information report that includes a second single transmission hypothesis associated with the second channel measurement resource, and a third channel state information report that includes a joint transmission hypothesis associated both a third channel measurement resource and a fourth channel measurement resource. The communications manager 1020 may be configured as or otherwise support a means for receiving, from the UE, uplink control information including the first channel state information report, the second channel state information report, and the third channel state information report ordered based on association of respective channel state information with either single transmission or joint transmission hypotheses.

By including or configuring the communications manager 1020 in accordance with examples as described herein, the device 1005 (e.g., a processor controlling or otherwise coupled to the receiver 1010, the transmitter 1015, the communications manager 1020, or a combination thereof) may support techniques for more efficient utilization of communication resources.

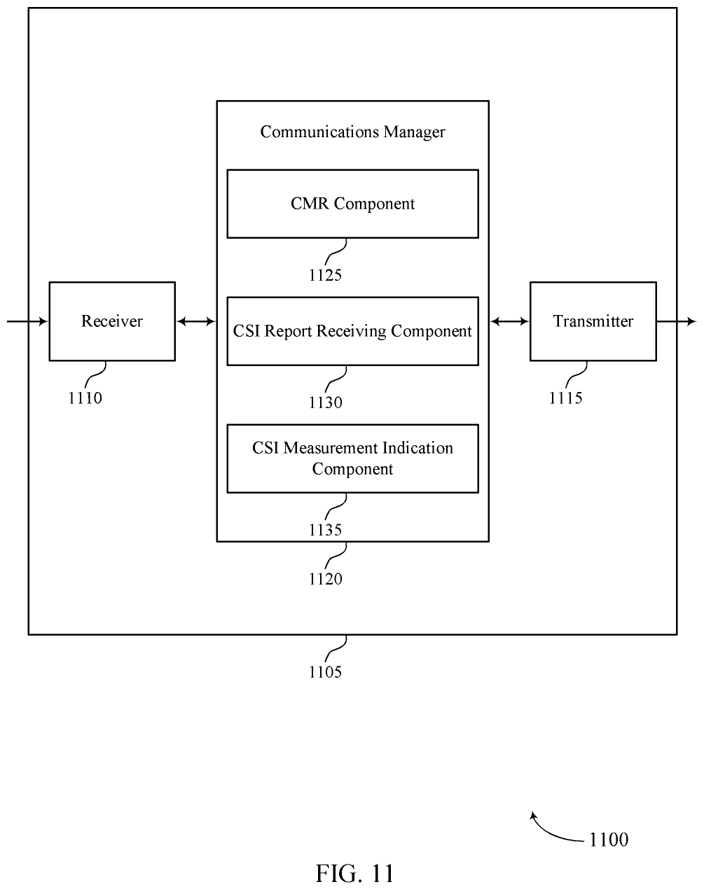

FIG. 11 shows a block diagram 1100 of a device 1105 that supports details of uplink control information payload and ordering for NCJT and single TRP CSI in accordance with aspects of the present disclosure. The device 1105 may be an example of aspects of a device 1005 or a base station 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to details of uplink control information payload and ordering for NCJT and single TRP CSI). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to details of uplink control information payload and ordering for NCJT and single TRP CSI). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of details of uplink control information payload and ordering for NCJT and single TRP CSI as described herein. For example, the communications manager 1120 may include an CMR component 1125, a CSI report receiving component 1130, a CSI measurement indication component 1135, or any combination thereof. The communications manager 1120 may be an example of aspects of a communications manager 1020 as described herein. In some examples, the communications manager 1120, or various components thereof, may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communications at a base station in accordance with examples as disclosed herein. The CMR component 1125 may be configured as or otherwise support a means for transmitting, to a UE, an indication of a first channel measurement resource and a second channel measurement resource in a channel measurement resource set, each configured for measuring channel state information reference signals by the UE, the first channel measurement resource associated with a first transmission configuration indicator state and the second channel measurement resource associated with a second transmission configuration indicator state. The CSI report receiving component 1130 may be configured as or otherwise support a means for receiving, from the UE, a channel state information report including channel state information for a joint transmission hypothesis, the channel state information including two rank indicators, two precoding matrix indicators, two layer indicators, or combinations thereof, each indicator of each pair of indicators associated with a respective one of either the first channel measurement resource or the second channel measurement resource, and an ordering of each indicator in at least one of the pairs of indicators associated with the first channel measurement resource and the second channel measurement resource.

Additionally or alternatively, the communications manager 1120 may support wireless communications at a base station in accordance with examples as disclosed herein. The CMR component 1125 may be configured as or otherwise support a means for transmitting, to a UE, an indication of a first channel measurement resource and a second channel measurement resource, each configured for measuring channel state information reference signals at the UE, the first channel measurement resource associated with a first transmission configuration indicator state and the second channel measurement resource associated with a second transmission configuration indicator state. The CSI measurement indication component 1135 may be configured as or otherwise support a means for transmitting, to the UE, a configuration for measuring channel state information reference signals for a first channel state information report that includes a first single transmission hypothesis associated with the first channel measurement resource, a second channel state information report that includes a second single transmission hypothesis associated with the second channel measurement resource, and a third channel state information report that includes a joint transmission hypothesis associated both a third channel measurement resource and a fourth channel measurement resource. The CSI report receiving component 1130 may be configured as or otherwise support a means for receiving, from the UE, uplink control information including the first channel state information report, the second channel state information report, and the third channel state information report ordered based on association of respective channel state information with either single transmission or joint transmission hypotheses.

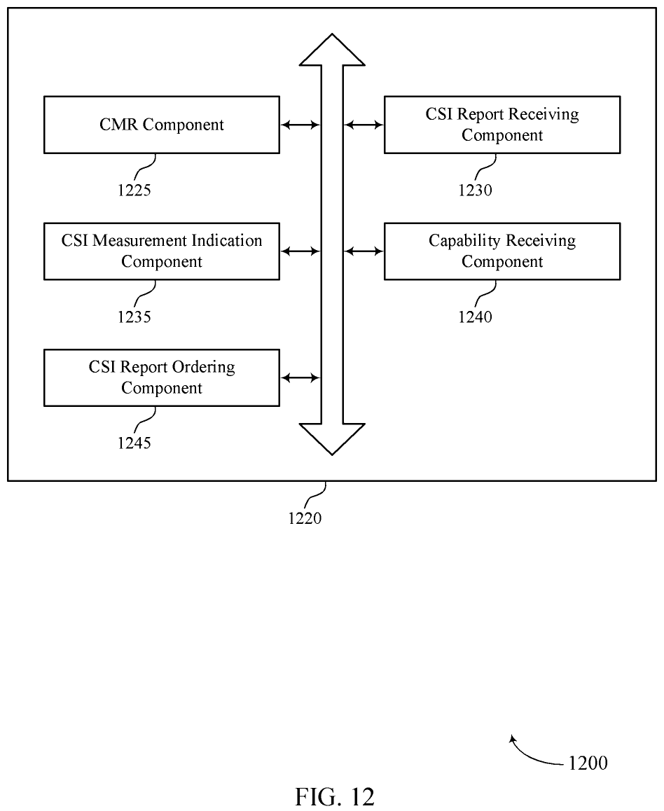

FIG. 12 shows a block diagram 1200 of a communications manager 1220 that supports details of uplink control information payload and ordering for NCJT and single TRP CSI in accordance with aspects of the present disclosure. The communications manager 1220 may be an example of aspects of a communications manager 1020, a communications manager 1120, or both, as described herein. The communications manager 1220, or various components thereof, may be an example of means for performing various aspects of details of uplink control information payload and ordering for NCJT and single TRP CSI as described herein. For example, the communications manager 1220 may include an CMR component 1225, a CSI report receiving component 1230, a CSI measurement indication component 1235, a capability receiving component 1240, a CSI report ordering component 1245, or any combination thereof. Each of these components may communicate, directly or indirectly, with one another (e.g., via one or more buses).

The communications manager 1220 may support wireless communications at a base station in accordance with examples as disclosed herein. The CMR component 1225 may be configured as or otherwise support a means for transmitting, to a UE, an indication of a first channel measurement resource and a second channel measurement resource in a channel measurement resource set, each configured for measuring channel state information reference signals by the UE, the first channel measurement resource associated with a first transmission configuration indicator state and the second channel measurement resource associated with a second transmission configuration indicator state. The CSI report receiving component 1230 may be configured as or otherwise support a means for receiving, from the UE, a channel state information report including channel state information for a joint transmission hypothesis, the channel state information including two rank indicators, two precoding matrix indicators, two layer indicators, or combinations thereof, each indicator of each pair of indicators associated with a respective one of either the first channel measurement resource or the second channel measurement resource, and an ordering of each indicator in at least one of the pairs of indicators associated with the first channel measurement resource and the second channel measurement resource.

In some examples, the ordering of each indicator in at least one of the pairs of indicators is based on a channel measurement resource ordering of the first channel measurement resource and the second channel measurement resource.

In some examples, the CSI report ordering component 1245 may be configured as or otherwise support a means for transmitting an implicit indication or an explicit indication of the channel measurement resource ordering.

In some examples, the ordering of each indicator in at least one of the pairs of indicators is based on a first indicator of the at least one of the pairs of indicators associated with the first channel measurement resource of a first channel measurement resource group and a second indicator of the at least one of the pairs of indicators with the second channel measurement resource of a second channel measurement resource group, the first channel measurement resource group and the second channel measurement resource group including the channel measurement resource set.

In some examples, the ordering of each indicator in the at least one of the pairs of indicators is based on an order of appearance of the first channel measurement resource and the second channel measurement resource in the channel measurement resource set.

In some examples, the ordering of each indicator in the at least one of the pairs of indicators based on respective values of a first channel state information reference signal resource identifier associated with the first channel measurement resource and a second channel state information reference signal resource identifier associated with the second channel measurement resource.

In some examples, the channel measurement resource associated with a first indicator has a lesser value than the channel measurement resource associated with a second indicator.

In some examples, the capability receiving component 1240 may be configured as or otherwise support a means for receiving, from the UE, a capability of the UE to transmit the channel state information report for the joint transmission hypothesis including the two rank indicators, two precoding matrix indicators, two layer indicators, or a combination thereof.

Additionally or alternatively, the communications manager 1220 may support wireless communications at a base station in accordance with examples as disclosed herein. In some examples, the CMR component 1225 may be configured as or otherwise support a means for transmitting, to a UE, an indication of a first channel measurement resource and a second channel measurement resource, each configured for measuring channel state information reference signals at the UE, the first channel measurement resource associated with a first transmission configuration indicator state and the second channel measurement resource associated with a second transmission configuration indicator state. The CSI measurement indication component 1235 may be configured as or otherwise support a means for transmitting, to the UE, a configuration for measuring channel state information reference signals for a first channel state information report that includes a first single transmission hypothesis associated with the first channel measurement resource, a second channel state information report that includes a second single transmission hypothesis associated with the second channel measurement resource, and a third channel state information report that includes a joint transmission hypothesis associated both a third channel measurement resource and a fourth channel measurement resource. In some examples, the CSI report receiving component 1230 may be configured as or otherwise support a means for receiving, from the UE, uplink control information including the first channel state information report, the second channel state information report, and the third channel state information report ordered based on association of respective channel state information with either single transmission or joint transmission hypotheses.

In some examples, to support receiving the uplink control information, the CSI report receiving component 1230 may be configured as or otherwise support a means for receiving the first channel state information report and the second channel state information report in a first portion of the uplink control information or receiving the third channel state information report to the first portion of the uplink control information.

In some examples, the CSI report receiving component 1230 may be configured as or otherwise support a means for receiving the first channel state information report and the second channel state information report in an order that based on corresponding channel state information reference signal resource indicator values, where the channel state information report corresponding to a lowest channel state information reference signal resource indicator value is first in the ordering.

In some examples, the CSI report receiving component 1230 may be configured as or otherwise support a means for receiving the first channel state information report and the second channel state information report in an order that is based on corresponding channel measurement resource groups for the channel state information reports, where the channel state information report associated with the first channel measurement resource group is first in the ordering.

In some examples, the CSI report receiving component 1230 may be configured as or otherwise support a means for receiving the first channel state information report and the second channel state information report in an order that is based on corresponding channel state information reference signal resource ID values, where the channel state information report corresponding to a lowest channel state information reference signal resource ID value is first in the ordering.

In some examples, the CSI report receiving component 1230 may be configured as or otherwise support a means for receiving the first channel state information report and the second channel state information report in an order that based on an order of appearance of corresponding channel measurement resources for the first channel state information report and the second channel state information report in a channel state information resource set, where the channel measurement resource appearing first in the channel state information resource set is first in the ordering.

In some examples, the uplink control information overlaps with at least one other uplink control information, the uplink control information multiplexed in accordance with the ordering of the first channel state information report, the second channel state information report, and the third channel state information report.

In some examples, the CSI report ordering component 1245 may be configured as or otherwise support a means for receiving the channel state information reports in an order that is first based on an order of the respective transmission hypothesis in the uplink control information, and second based on alternating sub-bands of the channel state information reports.

In some examples, the CSI report ordering component 1245 may be configured as or otherwise support a means for receiving the channel state information reports in an order that is first based on alternating sub-bands of the channel state information reports corresponding to and second based on an order of the respective transmission hypothesis in the uplink control information.

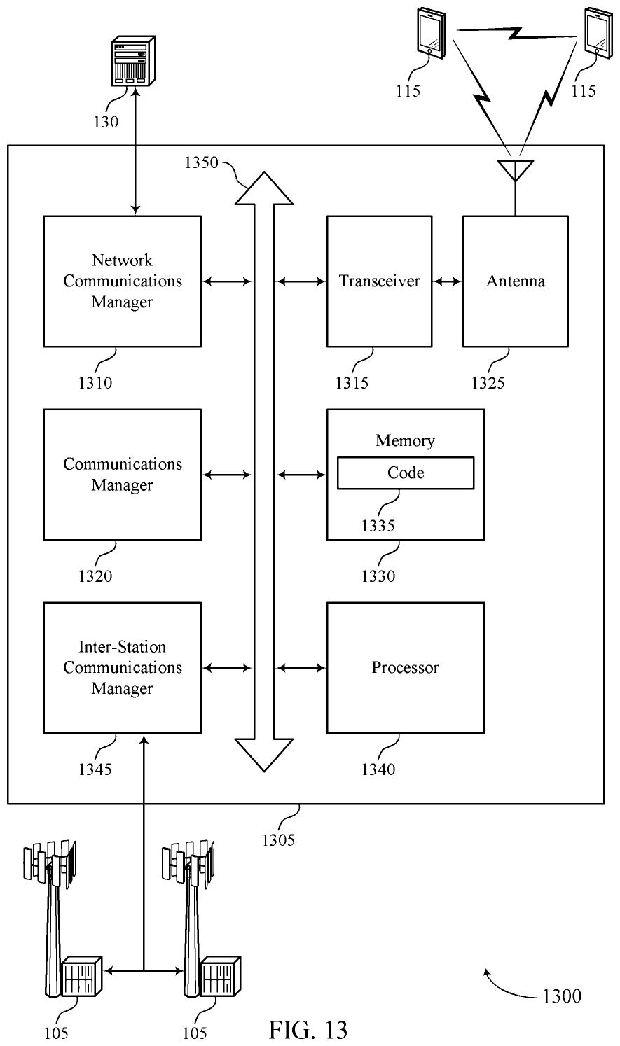

FIG. 13 shows a diagram of a system 1300 including a device 1305 that supports details of uplink control information payload and ordering for NCJT and single TRP CSI in accordance with aspects of the present disclosure. The device 1305 may be an example of or include the components of a device 1005, a device 1105, or a base station 105 as described herein. The device 1305 may communicate wirelessly with one or more base stations 105, UEs 115, or any combination thereof. The device 1305 may include components for bi-directional voice and data communications including components for transmitting and receiving communications, such as a communications manager 1320, a network communications manager 1310, a transceiver 1315, an antenna 1325, a memory 1330, code 1335, a processor 1340, and an inter-station communications manager 1345. These components may be in electronic communication or otherwise coupled (e.g., operatively, communicatively, functionally, electronically, electrically) via one or more buses (e.g., a bus 1350).

The network communications manager 1310 may manage communications with a core network 130 (e.g., via one or more wired backhaul links). For example, the network communications manager 1310 may manage the transfer of data communications for client devices, such as one or more UEs 115.

In some cases, the device 1305 may include a single antenna 1325. However, in some other cases the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include RAM and ROM. The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a BIOS which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting details of uplink control information payload and ordering for NCJT and single TRP CSI). For example, the device 1305 or a component of the device 1305 may include a processor 1340 and memory 1330 coupled to the processor 1340, the processor 1340 and memory 1330 configured to perform various functions described herein.

The inter-station communications manager 1345 may manage communications with other base stations 105, and may include a controller or scheduler for controlling communications with UEs 115 in cooperation with other base stations 105. For example, the inter-station communications manager 1345 may coordinate scheduling for transmissions to UEs 115 for various interference mitigation techniques such as beamforming or joint transmission. In some examples, the inter-station communications manager 1345 may provide an X2 interface within an LTE/LTE-A wireless communications network technology to provide communication between base stations 105.

The communications manager 1320 may support wireless communications at a base station in accordance with examples as disclosed herein. For example, the communications manager 1320 may be configured as or otherwise support a means for transmitting, to a UE, an indication of a first channel measurement resource and a second channel measurement resource in a channel measurement resource set, each configured for measuring channel state information reference signals by the UE, the first channel measurement resource associated with a first transmission configuration indicator state and the second channel measurement resource associated with a second transmission configuration indicator state. The communications manager 1320 may be configured as or otherwise support a means for receiving, from the UE, a channel state information report including channel state information for a joint transmission hypothesis, the channel state information including two rank indicators, two precoding matrix indicators, two layer indicators, or combinations thereof, each indicator of each pair of indicators associated with a respective one of either the first channel measurement resource or the second channel measurement resource, and an ordering of each indicator in at least one of the pairs of indicators associated with the first channel measurement resource and the second channel measurement resource.

Additionally or alternatively, the communications manager 1320 may support wireless communications at a base station in accordance with examples as disclosed herein. For example, the communications manager 1320 may be configured as or otherwise support a means for transmitting, to a UE, an indication of a first channel measurement resource and a second channel measurement resource, each configured for measuring channel state information reference signals at the UE, the first channel measurement resource associated with a first transmission configuration indicator state and the second channel measurement resource associated with a second transmission configuration indicator state. The communications manager 1320 may be configured as or otherwise support a means for transmitting, to the UE, a configuration for measuring channel state information reference signals for a first channel state information report that includes a first single transmission hypothesis associated with the first channel measurement resource, a second channel state information report that includes a second single transmission hypothesis associated with the second channel measurement resource, and a third channel state information report that includes a joint transmission hypothesis associated both a third channel measurement resource and a fourth channel measurement resource. The communications manager 1320 may be configured as or otherwise support a means for receiving, from the UE, uplink control information including the first channel state information report, the second channel state information report, and the third channel state information report ordered based on association of respective channel state information with either single transmission or joint transmission hypotheses.

By including or configuring the communications manager 1320 in accordance with examples as described herein, the device 1305 may support techniques for improved communication reliability, more efficient utilization of communication resources, and improved coordination between devices.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of details of uplink control information payload and ordering for NCJT and single TRP CSI as described herein, or the processor 1340 and the memory 1330 may be otherwise configured to perform or support such operations.

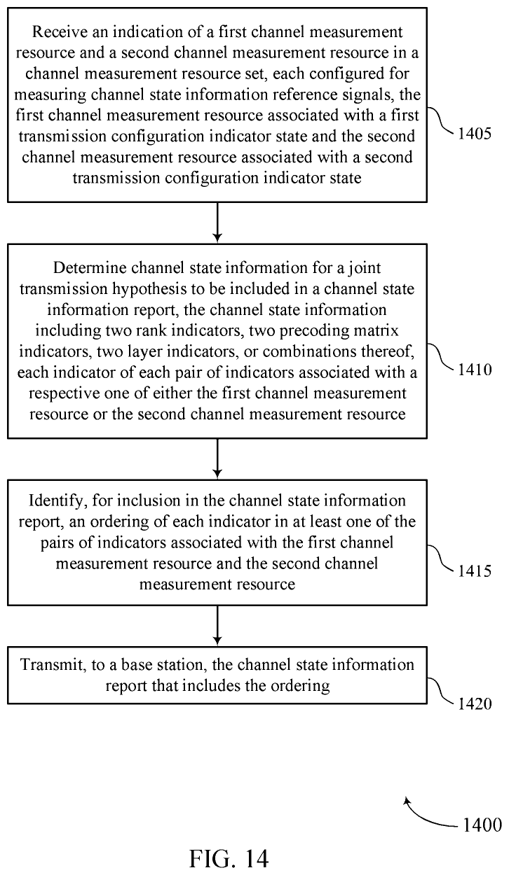

FIG. 14 shows a flowchart illustrating a method 1400 that supports details of uplink control information payload and ordering for NCJT and single TRP CSI in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1405, the method may include receiving an indication of a first channel measurement resource and a second channel measurement resource in a channel measurement resource set, each configured for measuring channel state information reference signals, the first channel measurement resource associated with a first transmission configuration indicator state and the second channel measurement resource associated with a second transmission configuration indicator state. The operations of 1405 may be performed in accordance with examples as disclosed herein. In some examples, aspects of the operations of 1405 may be performed by an CMR component 825 as described with reference to FIG. 8.

At 1410, the method may include determining channel state information for a joint transmission hypothesis to be included in a channel state information report, the channel state information including two rank indicators, two precoding matrix indicators, two layer indicators, or combinations thereof, each indicator of each pair of indicators associated with a respective one of either the first channel measurement resource or the second channel measurement resource. The operations of 1410 may be performed in accordance with examples as disclosed herein. In some examples, aspects of the operations of 1410 may be performed by a CSI report format component 830 as described with reference to FIG. 8.

At 1415, the method may include identifying, for inclusion in the channel state information report, an ordering of each indicator in at least one of the pairs of indicators associated with the first channel measurement resource and the second channel measurement resource. The operations of 1415 may be performed in accordance with examples as disclosed herein. In some examples, aspects of the operations of 1415 may be performed by a CSI report format component 830 as described with reference to FIG. 8.

At 1420, the method may include transmitting, to a base station, the channel state information report that includes the ordering. The operations of 1420 may be performed in accordance with examples as disclosed herein. In some examples, aspects of the operations of 1420 may be performed by a CSI report transmission component 835 as described with reference to FIG. 8.

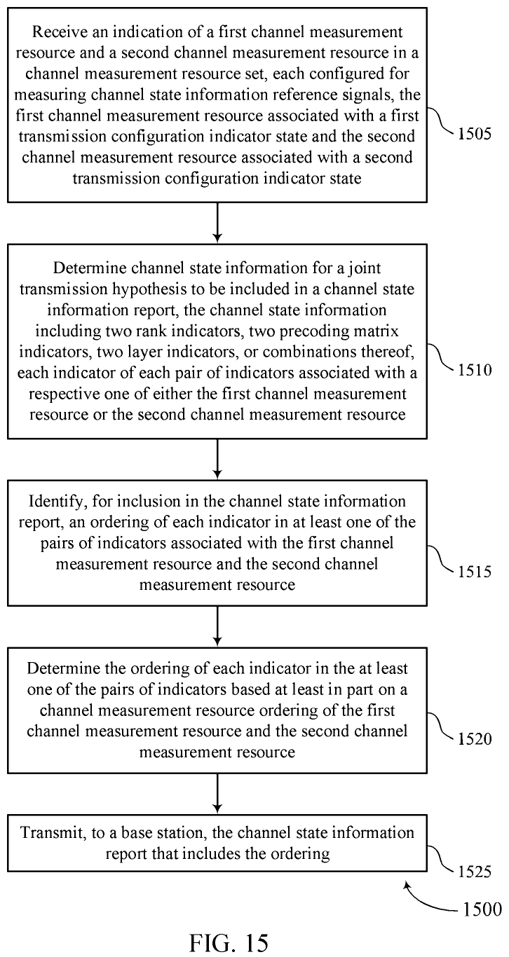

FIG. 15 shows a flowchart illustrating a method 1500 that supports details of uplink control information payload and ordering for NCJT and single TRP CSI in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1505, the method may include receiving an indication of a first channel measurement resource and a second channel measurement resource in a channel measurement resource set, each configured for measuring channel state information reference signals, the first channel measurement resource associated with a first transmission configuration indicator state and the second channel measurement resource associated with a second transmission configuration indicator state. The operations of 1505 may be performed in accordance with examples as disclosed herein. In some examples, aspects of the operations of 1505 may be performed by an CMR component 825 as described with reference to FIG. 8.

At 1510, the method may include determining channel state information for a joint transmission hypothesis to be included in a channel state information report, the channel state information including two rank indicators, two precoding matrix indicators, two layer indicators, or combinations thereof, each indicator of each pair of indicators associated with a respective one of either the first channel measurement resource or the second channel measurement resource. The operations of 1510 may be performed in accordance with examples as disclosed herein. In some examples, aspects of the operations of 1510 may be performed by a CSI report format component 830 as described with reference to FIG. 8.

At 1515, the method may include identifying, for inclusion in the channel state information report, an ordering of each indicator in at least one of the pairs of indicators associated with the first channel measurement resource and the second channel measurement resource. The operations of 1515 may be performed in accordance with examples as disclosed herein. In some examples, aspects of the operations of 1515 may be performed by a CSI report format component 830 as described with reference to FIG. 8.

At 1520, the method may include determining the ordering of each indicator in the at least one of the pairs of indicators based on a channel measurement resource ordering of the first channel measurement resource and the second channel measurement resource. The operations of 1520 may be performed in accordance with examples as disclosed herein. In some examples, aspects of the operations of 1520 may be performed by a CSI report format component 830 as described with reference to FIG. 8.

At 1525, the method may include transmitting, to a base station, the channel state information report that includes the ordering. The operations of 1525 may be performed in accordance with examples as disclosed herein. In some examples, aspects of the operations of 1525 may be performed by a CSI report transmission component 835 as described with reference to FIG. 8.

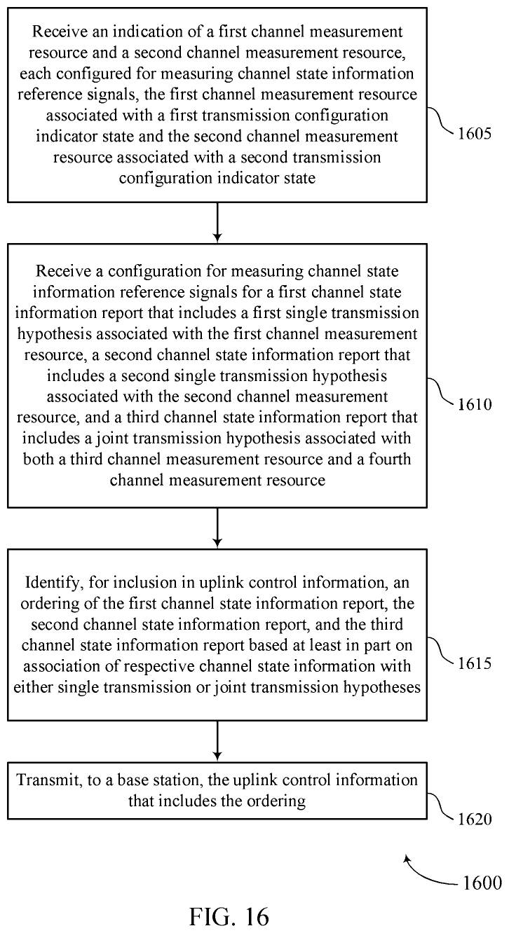

FIG. 16 shows a flowchart illustrating a method 1600 that supports details of uplink control information payload and ordering for NCJT and single TRP CSI in accordance with aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1605, the method may include receiving an indication of a first channel measurement resource and a second channel measurement resource, each configured for measuring channel state information reference signals, the first channel measurement resource associated with a first transmission configuration indicator state and the second channel measurement resource associated with a second transmission configuration indicator state. The operations of 1605 may be performed in accordance with examples as disclosed herein. In some examples, aspects of the operations of 1605 may be performed by an CMR component 825 as described with reference to FIG. 8.

At 1610, the method may include receiving a configuration for measuring channel state information reference signals for a first channel state information report that includes a first single transmission hypothesis associated with the first channel measurement resource, a second channel state information report that includes a second single transmission hypothesis associated with the second channel measurement resource, and a third channel state information report that includes a joint transmission hypothesis associated with both a third channel measurement resource and a fourth channel measurement resource. The operations of 1610 may be performed in accordance with examples as disclosed herein. In some examples, aspects of the operations of 1610 may be performed by a CSI report ordering component 840 as described with reference to FIG. 8.

At 1615, the method may include identifying, for inclusion in uplink control information, an ordering of the first channel state information report, the second channel state information report, and the third channel state information report based on association of respective channel state information with either single transmission or joint transmission hypotheses. The operations of 1615 may be performed in accordance with examples as disclosed herein. In some examples, aspects of the operations of 1615 may be performed by a CSI report format component 830 as described with reference to FIG. 8.

At 1620, the method may include transmitting, to a base station, the uplink control information that includes the ordering. The operations of 1620 may be performed in accordance with examples as disclosed herein. In some examples, aspects of the operations of 1620 may be performed by a CSI report transmission component 835 as described with reference to FIG. 8.

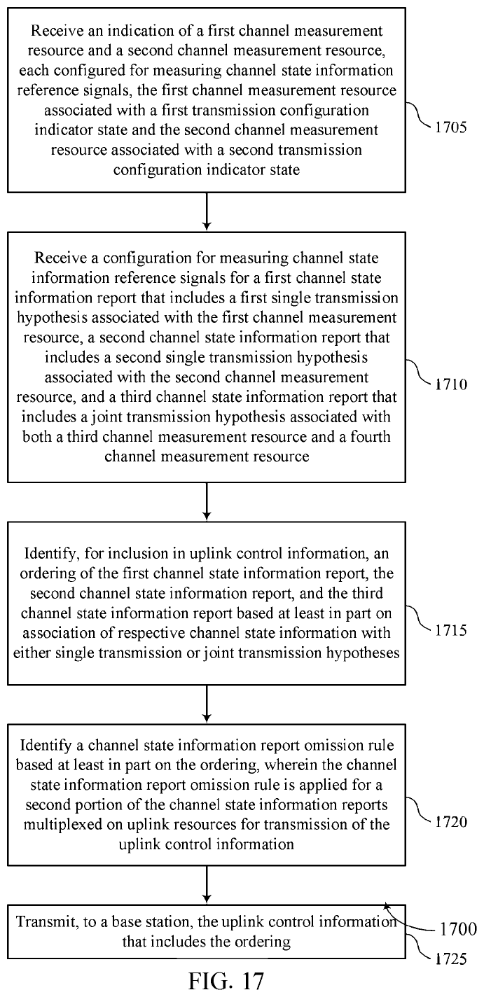

FIG. 17 shows a flowchart illustrating a method 1700 that supports details of uplink control information payload and ordering for NCJT and single TRP CSI in accordance with aspects of the present disclosure. The operations of the method 1700 may be implemented by a UE or its components as described herein. For example, the operations of the method 1700 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1705, the method may include receiving an indication of a first channel measurement resource and a second channel measurement resource, each configured for measuring channel state information reference signals, the first channel measurement resource associated with a first transmission configuration indicator state and the second channel measurement resource associated with a second transmission configuration indicator state. The operations of 1705 may be performed in accordance with examples as disclosed herein. In some examples, aspects of the operations of 1705 may be performed by an CMR component 825 as described with reference to FIG. 8.

At 1710, the method may include receiving a configuration for measuring channel state information reference signals for a first channel state information report that includes a first single transmission hypothesis associated with the first channel measurement resource, a second channel state information report that includes a second single transmission hypothesis associated with the second channel measurement resource, and a third channel state information report that includes a joint transmission hypothesis associated with both a third channel measurement resource and a fourth channel measurement resource. The operations of 1710 may be performed in accordance with examples as disclosed herein. In some examples, aspects of the operations of 1710 may be performed by a CSI report ordering component 840 as described with reference to FIG. 8.

At 1715, the method may include identifying, for inclusion in uplink control information, an ordering of the first channel state information report, the second channel state information report, and the third channel state information report based on association of respective channel state information with either single transmission or joint transmission hypotheses. The operations of 1715 may be performed in accordance with examples as disclosed herein. In some examples, aspects of the operations of 1715 may be performed by a CSI report format component 830 as described with reference to FIG. 8.

At 1720, the method may include identifying a channel state information report omission rule based on the ordering, where the channel state information report omission rule is applied for a second portion of the channel state information reports multiplexed on uplink resources for transmission of the uplink control information. The operations of 1720 may be performed in accordance with examples as disclosed herein. In some examples, aspects of the operations of 1720 may be performed by a CSI report omission component 850 as described with reference to FIG. 8.

At 1725, the method may include transmitting, to a base station, the uplink control information that includes the ordering. The operations of 1725 may be performed in accordance with examples as disclosed herein. In some examples, aspects of the operations of 1725 may be performed by a CSI report transmission component 835 as described with reference to FIG. 8.

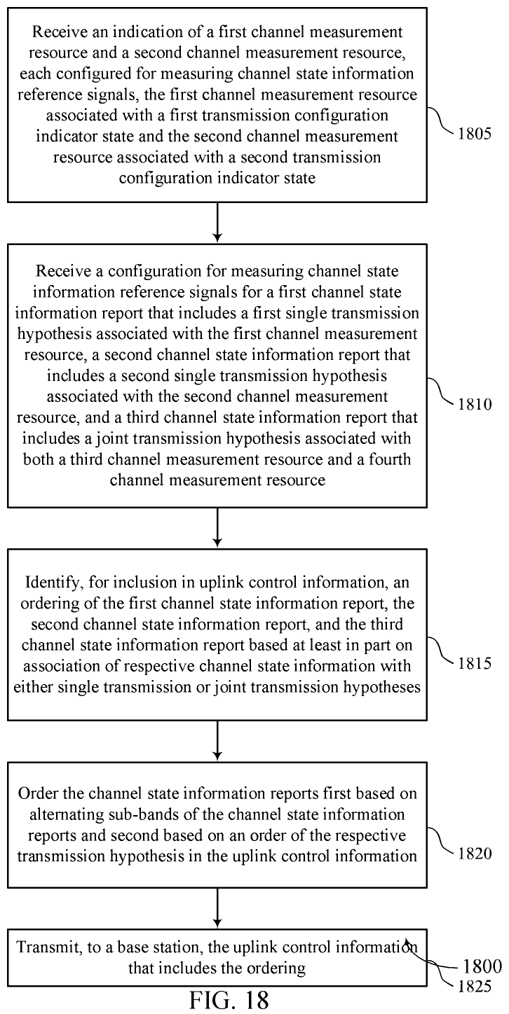

FIG. 18 shows a flowchart illustrating a method 1800 that supports details of uplink control information payload and ordering for NCJT and single TRP CSI in accordance with aspects of the present disclosure. The operations of the method 1800 may be implemented by a UE or its components as described herein. For example, the operations of the method 1800 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1805, the method may include receiving an indication of a first channel measurement resource and a second channel measurement resource, each configured for measuring channel state information reference signals, the first channel measurement resource associated with a first transmission configuration indicator state and the second channel measurement resource associated with a second transmission configuration indicator state. The operations of 1805 may be performed in accordance with examples as disclosed herein. In some examples, aspects of the operations of 1805 may be performed by an CMR component 825 as described with reference to FIG. 8.

At 1810, the method may include receiving a configuration for measuring channel state information reference signals for a first channel state information report that includes a first single transmission hypothesis associated with the first channel measurement resource, a second channel state information report that includes a second single transmission hypothesis associated with the second channel measurement resource, and a third channel state information report that includes a joint transmission hypothesis associated with both a third channel measurement resource and a fourth channel measurement resource. The operations of 1810 may be performed in accordance with examples as disclosed herein. In some examples, aspects of the operations of 1810 may be performed by a CSI report ordering component 840 as described with reference to FIG. 8.

At 1815, the method may include identifying, for inclusion in uplink control information, an ordering of the first channel state information report, the second channel state information report, and the third channel state information report based on association of respective channel state information with either single transmission or joint transmission hypotheses. The operations of 1815 may be performed in accordance with examples as disclosed herein. In some examples, aspects of the operations of 1815 may be performed by a CSI report format component 830 as described with reference to FIG. 8.

At 1820, the method may include ordering the channel state information reports first based on alternating sub-bands of the channel state information reports and second based on an order of the respective transmission hypothesis in the uplink control information. The operations of 1820 may be performed in accordance with examples as disclosed herein. In some examples, aspects of the operations of 1820 may be performed by a CSI report ordering component 840 as described with reference to FIG. 8.

At 1825, the method may include transmitting, to a base station, the uplink control information that includes the ordering. The operations of 1825 may be performed in accordance with examples as disclosed herein. In some examples, aspects of the operations of 1825 may be performed by a CSI report transmission component 835 as described with reference to FIG. 8.

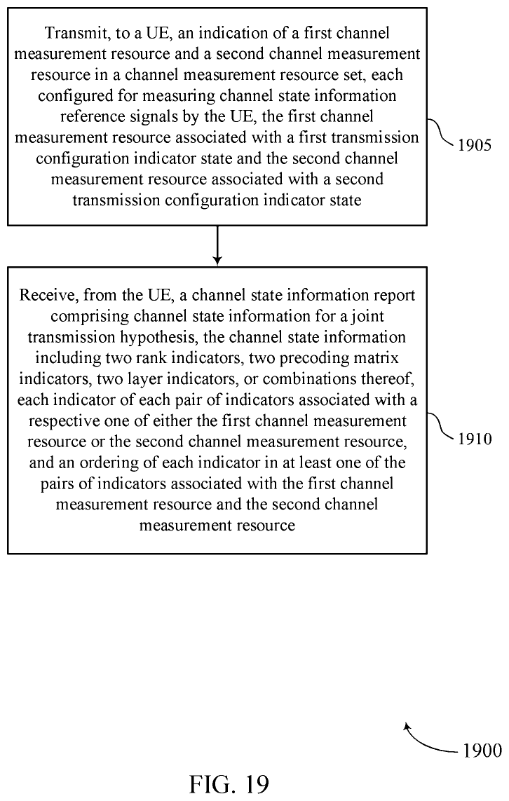

FIG. 19 shows a flowchart illustrating a method 1900 that supports details of uplink control information payload and ordering for NCJT and single TRP CSI in accordance with aspects of the present disclosure. The operations of the method 1900 may be implemented by a base station or its components as described herein. For example, the operations of the method 1900 may be performed by a base station 105 as described with reference to FIGS. 1 through 5 and 10 through 13. In some examples, a base station may execute a set of instructions to control the functional elements of the base station to perform the described functions. Additionally or alternatively, the base station may perform aspects of the described functions using special-purpose hardware.

At 1905, the method may include transmitting, to a UE, an indication of a first channel measurement resource and a second channel measurement resource in a channel measurement resource set, each configured for measuring channel state information reference signals by the UE, the first channel measurement resource associated with a first transmission configuration indicator state and the second channel measurement resource associated with a second transmission configuration indicator state. The operations of 1905 may be performed in accordance with examples as disclosed herein. In some examples, aspects of the operations of 1905 may be performed by an CMR component 1225 as described with reference to FIG. 12.

At 1910, the method may include receiving, from the UE, a channel state information report including channel state information for a joint transmission hypothesis, the channel state information including two rank indicators, two precoding matrix indicators, two layer indicators, or combinations thereof, each indicator of each pair of indicators associated with a respective one of either the first channel measurement resource or the second channel measurement resource, and an ordering of each indicator in at least one of the pairs of indicators associated with the first channel measurement resource and the second channel measurement resource. The operations of 1910 may be performed in accordance with examples as disclosed herein. In some examples, aspects of the operations of 1910 may be performed by a CSI report receiving component 1230 as described with reference to FIG. 12.

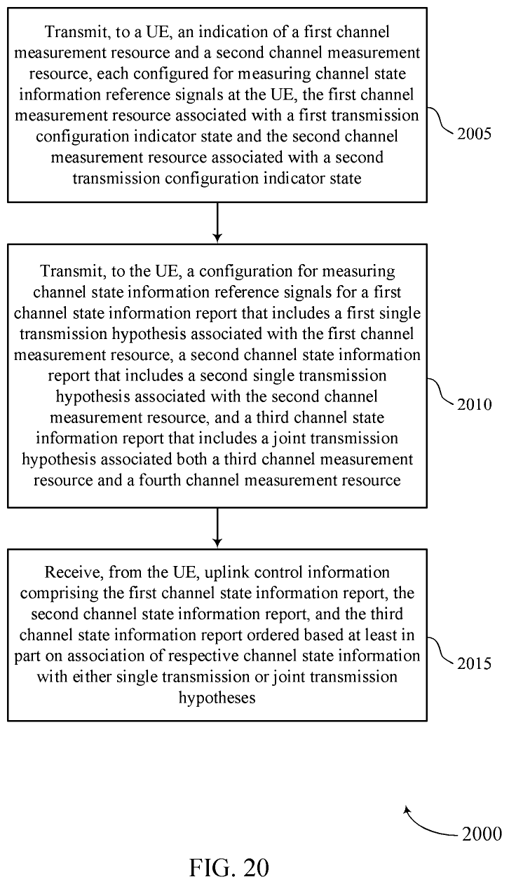

FIG. 20 shows a flowchart illustrating a method 2000 that supports details of uplink control information payload and ordering for NCJT and single TRP CSI in accordance with aspects of the present disclosure. The operations of the method 2000 may be implemented by a base station or its components as described herein. For example, the operations of the method 2000 may be performed by a base station 105 as described with reference to FIGS. 1 through 5 and 10 through 13. In some examples, a base station may execute a set of instructions to control the functional elements of the base station to perform the described functions. Additionally or alternatively, the base station may perform aspects of the described functions using special-purpose hardware.

At 2005, the method may include transmitting, to a UE, an indication of a first channel measurement resource and a second channel measurement resource, each configured for measuring channel state information reference signals at the UE, the first channel measurement resource associated with a first transmission configuration indicator state and the second channel measurement resource associated with a second transmission configuration indicator state. The operations of 2005 may be performed in accordance with examples as disclosed herein. In some examples, aspects of the operations of 2005 may be performed by an CMR component 1225 as described with reference to FIG. 12.

At 2010, the method may include transmitting, to the UE, a configuration for measuring channel state information reference signals for a first channel state information report that includes a first single transmission hypothesis associated with the first channel measurement resource, a second channel state information report that includes a second single transmission hypothesis associated with the second channel measurement resource, and a third channel state information report that includes a joint transmission hypothesis associated both a third channel measurement resource and a fourth channel measurement resource. The operations of 2010 may be performed in accordance with examples as disclosed herein. In some examples, aspects of the operations of 2010 may be performed by a CSI measurement indication component 1235 as described with reference to FIG. 12.

At 2015, the method may include receiving, from the UE, uplink control information including the first channel state information report, the second channel state information report, and the third channel state information report ordered based on association of respective channel state information with either single transmission or joint transmission hypotheses. The operations of 2015 may be performed in accordance with examples as disclosed herein. In some examples, aspects of the operations of 2015 may be performed by a CSI report receiving component 1230 as described with reference to FIG. 12.

The following provides an overview of aspects of the present disclosure:

Aspect 1: A method for wireless communications at a UE, comprising: receiving an indication of a first CMR and a second CMR in a CMR set, each configured for measuring CSI reference signals, the first CMR associated with a first TCI state and the second CMR associated with a second TCI state; determining CSI for a joint transmission hypothesis to be included in a CSI report, the CSI including two RIs, two PMIs, two Us, or combinations thereof, each indicator of each pair of indicators associated with a respective one of either the first CMR or the second CMR; identifying, for inclusion in the CSI report, an ordering of each indicator in at least one of the pairs of indicators associated with the first CMR and the second CMR; and transmitting, to a base station, the CSI report that includes the ordering.

Aspect 2: The method of aspect 1, wherein identifying the ordering of each indicator in at least one of the pairs of indicators comprises: determining the ordering of each indicator in the at least one of the pairs of indicators based at least in part on a CMR ordering of the first CMR and the second CMR.

Aspect 3: The method of aspect 2, further comprising: receiving an implicit indication or an explicit indication of the CMR ordering.

Aspect 4: The method of any of aspects 1 through 3, wherein identifying the ordering of each indicator in at least one of the pairs of indicators comprises: determining the ordering of each indicator in the at least one of the pairs of indicators by associating a first indicator of the at least one of the pairs of indicators with the first CMR based on the first CMR being associated with a first CMR group and a second indicator of the at least one of the pairs of indicators with the second CMR based on the second CMR being associated with a second CMR group, the first CMR group and the second CMR group comprising the CMR set.

Aspect 5: The method of any of aspects 1 through 4, wherein identifying the ordering of each indicator in at least one of the pairs of indicators comprises: determining the ordering of each indicator in the at least one of the pairs of indicators based at least in part on an order of appearance of the first CMR and the second CMR in the CMR set.

Aspect 6: The method of any of aspects 1 through 5, wherein identifying the ordering of each indicator in at least one of the pairs of indicators comprises: identifying a first CSI reference signal resource identifier associated with the first CMR and a second CSI reference signal resource identifier associated with the second CMR; and determining the ordering of each indicator in the at least one of the pairs of indicators based at least in part on respective values of the first CSI reference signal resource identifier and the second CSI reference signal resource identifier.

Aspect 7: The method of aspect 6, wherein the CMR associated with a first indicator has a lesser value than the CMR associated with a second indicator.

Aspect 8: The method of any of aspects 1 through 7, further comprising: transmitting, to the base station, a capability of the UE to transmit the CSI report for the joint transmission hypothesis comprising the two RIs, two PMIs, two Us, or a combination thereof.

Aspect 9: A method for wireless communications at a UE, comprising: receiving an indication of a first CMR and a second CMR, each configured for measuring CSI reference signals, the first CMR associated with a first TCI state and the second CMR associated with a second TCI state; receiving a configuration for measuring CSI reference signals for a first CSI report that includes a first single transmission hypothesis associated with the first CMR, a second CSI report that includes a second single transmission hypothesis associated with the second CMR, and a third CSI report that includes a joint transmission hypothesis associated with both a third CMR and a fourth CMR; identifying, for inclusion in UCI, an ordering of the first CSI report, the second CSI report, and the third CSI report based at least in part on association of respective CSI with either single transmission or joint transmission hypotheses; and transmitting, to a base station, the UCI that includes the ordering.

Aspect 10: The method of aspect 9, wherein the identifying of the ordering of the first CSI report, the second CSI report, and the third CSI report further comprises: allocating the first CSI report and the second CSI report to a first portion of the UCI or allocating the third CSI report to the first portion of the UCI.

Aspect 11: The method of aspect 10, further comprising: ordering the first CSI report and the second CSI report based at least in part on corresponding CSI reference signal resource indicator values, wherein the CSI report corresponding to a lowest CSI reference signal resource indicator value is first in the ordering.

Aspect 12: The method of any of aspects 10 through 11, further comprising: ordering the first CSI report and the second CSI report based at least in part on corresponding CMR groups for the CSI reports, wherein the CSI report associated with the first CMR group is first in the ordering.

Aspect 13: The method of any of aspects 10 through 12, further comprising: ordering the first CSI report and the second CSI report based at least in part on corresponding CSI reference signal resource ID values, wherein the CSI report corresponding to a lowest CSI reference signal resource ID value is first in the ordering.

Aspect 14: The method of any of aspects 10 through 13, further comprising: ordering the first CSI report and the second CSI report based at least in part on an order of appearance of corresponding CMRs for the first CSI report and the second CSI report in a CSI resource set, wherein the CMR appearing first in the CSI resource set is first in the ordering.

Aspect 15: The method of any of aspects 9 through 14, further comprising: identifying a CSI report omission rule based at least in part on the ordering, wherein the CSI report omission rule is applied for a second portion of the CSI reports multiplexed on uplink resources for transmission of the UCI.

Aspect 16: The method of any of aspects 9 through 15, wherein the UCI overlaps with at least one other UCI, the UCI multiplexed in accordance with the ordering of the first CSI report, the second CSI report, and the third CSI report.

Aspect 17: The method of any of aspects 9 through 16, wherein the ordering further comprises: ordering the CSI reports first based on an order of the respective transmission hypothesis in the UCI, and second based on alternating sub-bands of the CSI reports.

Aspect 18: The method of any of aspects 9 through 17, wherein the ordering further comprises: ordering the CSI reports first based on alternating sub-bands of the CSI reports and second based on an order of the respective transmission hypothesis in the UCI.

Aspect 19: A method for wireless communications at a base station, comprising: transmitting, to a UE, an indication of a first CMR and a second CMR in a CMR set, each configured for measuring CSI reference signals by the UE, the first CMR associated with a first TCI state and the second CMR associated with a second TCI state; receiving, from the UE, a CSI report comprising CSI for a joint transmission hypothesis, the CSI including two RIs, two PMIs, two Us, or combinations thereof, each indicator of each pair of indicators associated with a respective one of either the first CMR or the second CMR, and an ordering of each indicator in at least one of the pairs of indicators associated with the first CMR and the second CMR.

Aspect 20: The method of aspect 19, wherein the ordering of each indicator in at least one of the pairs of indicators is based at least in part on a CMR ordering of the first CMR and the second CMR.

Aspect 21: The method of aspect 20, further comprising: transmitting an implicit indication or an explicit indication of the CMR ordering.

Aspect 22: The method of any of aspects 19 through 21, wherein the ordering of each indicator in at least one of the pairs of indicators is based on a first indicator of the at least one of the pairs of indicators associated with the first CMR of a first CMR group and a second indicator of the at least one of the pairs of indicators with the second CMR of a second CMR group, the first CMR group and the second CMR group comprising the CMR set.

Aspect 23: The method of any of aspects 19 through 22, wherein the ordering of each indicator in the at least one of the pairs of indicators is based at least in part on an order of appearance of the first CMR and the second CMR in the CMR set.

Aspect 24: The method of any of aspects 19 through 23, wherein the ordering of each indicator in the at least one of the pairs of indicators based at least in part on respective values of a first CSI reference signal resource identifier associated with the first CMR and a second CSI reference signal resource identifier associated with the second CMR.

Aspect 25: The method of aspect 24, wherein the CMR associated with a first indicator has a lesser value than the CMR associated with a second indicator.

Aspect 26: The method of any of aspects 19 through 25, further comprising: receiving, from the UE, a capability of the UE to transmit the CSI report for the joint transmission hypothesis comprising the two RIs, two PMIs, two Us, or a combination thereof.

Aspect 27: A method for wireless communications at a base station, comprising: transmitting, to a UE, an indication of a first CMR and a second CMR, each configured for measuring CSI reference signals at the UE, the first CMR associated with a first TCI state and the second CMR associated with a second TCI state; transmitting, to the UE, a configuration for measuring CSI reference signals for a first CSI report that includes a first single transmission hypothesis associated with the first CMR, a second CSI report that includes a second single transmission hypothesis associated with the second CMR, and a third CSI report that includes a joint transmission hypothesis associated both a third CMR and a fourth CMR; receiving, from the UE, UCI comprising the first CSI report, the second CSI report, and the third CSI report ordered based at least in part on association of respective CSI with either single transmission or joint transmission hypotheses.

Aspect 28: The method of aspect 27, wherein receiving the UCI further comprises: receiving the first CSI report and the second CSI report in a first portion of the UCI or receiving the third CSI report to the first portion of the UCI.

Aspect 29: The method of aspect 28, further comprising: receiving the first CSI report and the second CSI report in an order that based at least in part on corresponding CSI reference signal resource indicator values, wherein the CSI report corresponding to a lowest CSI reference signal resource indicator value is first in the ordering.

Aspect 30: The method of any of aspects 28 through 29, further comprising: receiving the first CSI report and the second CSI report in an order that is based at least in part on corresponding CMR groups for the CSI reports, wherein the CSI report associated with the first CMR group is first in the ordering.

Aspect 31: The method of any of aspects 28 through 30, further comprising: receiving the first CSI report and the second CSI report in an order that is based at least in part on corresponding CSI reference signal resource ID values, wherein the CSI report corresponding to a lowest CSI reference signal resource ID value is first in the ordering.

Aspect 32: The method of any of aspects 28 through 31, further comprising: receiving the first CSI report and the second CSI report in an order that based at least in part on an order of appearance of corresponding CMRs for the first CSI report and the second CSI report in a CSI resource set, wherein the CMR appearing first in the CSI resource set is first in the ordering.

Aspect 33: The method of any of aspects 27 through 32, wherein the UCI overlaps with at least one other UCI, the UCI multiplexed in accordance with the ordering of the first CSI report, the second CSI report, and the third CSI report.

Aspect 34: The method of any of aspects 27 through 33, further comprising: receiving the CSI reports in an order that is first based on an order of the respective transmission hypothesis in the UCI, and second based on alternating sub-bands of the CSI reports.

Aspect 35: The method of any of aspects 27 through 34, further comprising: receiving the CSI reports in an order that is first based on alternating sub-bands of the CSI reports corresponding to and second based on an order of the respective transmission hypothesis in the UCI.

Aspect 36: An apparatus for wireless communications at a UE, comprising a processor; memory coupled with the processor; and instructions stored in the memory and executable by the processor to cause the apparatus to perform a method of any of aspects 1 through 8.

Aspect 37: An apparatus for wireless communications at a UE, comprising at least one means for performing a method of any of aspects 1 through 8.

Aspect 38: A non-transitory computer-readable medium storing code for wireless communications at a UE, the code comprising instructions executable by a processor to perform a method of any of aspects 1 through 8.

Aspect 39: An apparatus for wireless communications at a UE, comprising a processor; memory coupled with the processor; and instructions stored in the memory and executable by the processor to cause the apparatus to perform a method of any of aspects 9 through 18.

Aspect 40: An apparatus for wireless communications at a UE, comprising at least one means for performing a method of any of aspects 9 through 18.

Aspect 41: A non-transitory computer-readable medium storing code for wireless communications at a UE, the code comprising instructions executable by a processor to perform a method of any of aspects 9 through 18.

Aspect 42: An apparatus for wireless communications at a base station, comprising a processor; memory coupled with the processor; and instructions stored in the memory and executable by the processor to cause the apparatus to perform a method of any of aspects 19 through 26.

Aspect 43: An apparatus for wireless communications at a base station, comprising at least one means for performing a method of any of aspects 19 through 26.

Aspect 44: A non-transitory computer-readable medium storing code for wireless communications at a base station, the code comprising instructions executable by a processor to perform a method of any of aspects 19 through 26.

Aspect 45: An apparatus for wireless communications at a base station, comprising a processor; memory coupled with the processor; and instructions stored in the memory and executable by the processor to cause the apparatus to perform a method of any of aspects 27 through 35.

Aspect 46: An apparatus for wireless communications at a base station, comprising at least one means for performing a method of any of aspects 27 through 35.

Aspect 47: A non-transitory computer-readable medium storing code for wireless communications at a base station, the code comprising instructions executable by a processor to perform a method of any of aspects 27 through 35.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
receiving an indication of a first channel measurement resource and a second channel measurement resource in a channel measurement resource set, each configured for measuring channel state information reference signals, the first channel measurement resource associated with a first transmission configuration indicator state and the second channel measurement resource associated with a second transmission configuration indicator state;
determining channel state information for a joint transmission hypothesis to be included in a channel state information report, the channel state information including two rank indicators, two precoding matrix indicators, two layer indicators, or combinations thereof, each indicator of each pair of indicators associated with a respective one of either the first channel measurement resource or the second channel measurement resource;
identifying, for inclusion in the channel state information report, an ordering of each indicator in at least one of the pairs of indicators associated with the first channel measurement resource and the second channel measurement resource; and
transmitting, to a base station, the channel state information report that includes the ordering.

2. The method of claim 1, wherein identifying the ordering of each indicator in at least one of the pairs of indicators comprises:
determining the ordering of each indicator in the at least one of the pairs of indicators based at least in part on a channel measurement resource ordering of the first channel measurement resource and the second channel measurement resource.

3. The method of claim 2, further comprising:
receiving an implicit indication or an explicit indication of the channel measurement resource ordering.

4. The method of claim 1, wherein identifying the ordering of each indicator in at least one of the pairs of indicators comprises:
determining the ordering of each indicator in the at least one of the pairs of indicators by associating a first indicator of the at least one of the pairs of indicators with the first channel measurement resource based on the first channel measurement resource being associated with a first channel measurement resource group and a second indicator of the at least one of the pairs of indicators with the second channel measurement resource based on the second channel measurement resource being associated with a second channel measurement resource group, the first channel measurement resource group and the second channel measurement resource group comprising the channel measurement resource set.

5. The method of claim 1, wherein identifying the ordering of each indicator in at least one of the pairs of indicators comprises:
determining the ordering of each indicator in the at least one of the pairs of indicators based at least in part on an order of appearance of the first channel measurement resource and the second channel measurement resource in the channel measurement resource set.

6. The method of claim 1, wherein identifying the ordering of each indicator in at least one of the pairs of indicators comprises:
identifying a first channel state information reference signal resource identifier associated with the first channel measurement resource and a second channel state information reference signal resource identifier associated with the second channel measurement resource; and
determining the ordering of each indicator in the at least one of the pairs of indicators based at least in part on respective values of the first channel state information reference signal resource identifier and the second channel state information reference signal resource identifier.

7. The method of claim 6, wherein the channel measurement resource associated with a first indicator has a lesser value than the channel measurement resource associated with a second indicator.

8. The method of claim 1, further comprising:
transmitting, to the base station, a capability of the UE to transmit the channel state information report for the joint transmission hypothesis comprising the two rank indicators, two precoding matrix indicators, two layer indicators, or a combination thereof.

9. A method for wireless communications at a user equipment (UE), comprising:
receiving an indication of a first channel measurement resource and a second channel measurement resource, each configured for measuring channel state information reference signals, the first channel measurement resource associated with a first transmission configuration indicator state and the second channel measurement resource associated with a second transmission configuration indicator state;
receiving a configuration for measuring channel state information reference signals for a first channel state information report that includes a first single transmission hypothesis associated with the first channel measurement resource, a second channel state information report that includes a second single transmission hypothesis associated with the second channel measurement resource, and a third channel state information report that includes a joint transmission hypothesis associated with both a third channel measurement resource and a fourth channel measurement resource;
identifying, for inclusion in uplink control information, an ordering of the first channel state information report, the second channel state information report, and the third channel state information report based at least in part on association of respective channel state information with either single transmission or joint transmission hypotheses; and
transmitting, to a base station, the uplink control information that includes the ordering.

10. The method of claim 9, wherein the identifying of the ordering of the first channel state information report, the second channel state information report, and the third channel state information report further comprises:
allocating the first channel state information report and the second channel state information report to a first portion of the uplink control information or allocating the third channel state information report to the first portion of the uplink control information.

11. The method of claim 10, further comprising:
ordering the first channel state information report and the second channel state information report based at least in part on corresponding channel state information reference signal resource indicator values, wherein the channel state information report corresponding to a lowest channel state information reference signal resource indicator value is first in the ordering.

12. The method of claim 10, further comprising:
ordering the first channel state information report and the second channel state information report based at least in part on corresponding channel measurement resource groups for the channel state information reports, wherein the channel state information report associated with the first channel measurement resource group is first in the ordering.

13. The method of claim 10, further comprising:
ordering the first channel state information report and the second channel state information report based at least in part on corresponding channel state information reference signal resource ID values, wherein the channel state information report corresponding to a lowest channel state information reference signal resource ID value is first in the ordering.

14. The method of claim 10, further comprising:
ordering the first channel state information report and the second channel state information report based at least in part on an order of appearance of corresponding channel measurement resources for the first channel state information report and the second channel state information report in a channel state information resource set, wherein the channel measurement resource appearing first in the channel state information resource set is first in the ordering.

15. The method of claim 9, further comprising:
identifying a channel state information report omission rule based at least in part on the ordering, wherein the channel state information report omission rule is applied for a second portion of the channel state information reports multiplexed on uplink resources for transmission of the uplink control information.

16. The method of claim 9, wherein the uplink control information overlaps with at least one other uplink control information, the uplink control information multiplexed in accordance with the ordering of the first channel state information report, the second channel state information report, and the third channel state information report.

17. The method of claim 9, wherein the ordering further comprises:
ordering the channel state information reports first based on an order of the respective transmission hypothesis in the uplink control information, and second based on alternating sub-bands of the channel state information reports.

18. The method of claim 9, wherein the ordering further comprises:
ordering the channel state information reports first based on alternating sub-bands of the channel state information reports and second based on an order of the respective transmission hypothesis in the uplink control information.

19. A method for wireless communications at a base station, comprising:
transmitting, to a user equipment (UE), an indication of a first channel measurement resource and a second channel measurement resource in a channel measurement resource set, each configured for measuring channel state information reference signals by the UE, the first channel measurement resource associated with a first transmission configuration indicator state and the second channel measurement resource associated with a second transmission configuration indicator state;
receiving, from the UE, a channel state information report comprising channel state information for a joint transmission hypothesis, the channel state information including two rank indicators, two precoding matrix indicators, two layer indicators, or combinations thereof, each indicator of each pair of indicators associated with a respective one of either the first channel measurement resource or the second channel measurement resource, and an ordering of each indicator in at least one of the pairs of indicators associated with the first channel measurement resource and the second channel measurement resource.

20. The method of claim 19, wherein the ordering of each indicator in at least one of the pairs of indicators is based at least in part on a channel measurement resource ordering of the first channel measurement resource and the second channel measurement resource.

21. The method of claim 20, further comprising:
transmitting an implicit indication or an explicit indication of the channel measurement resource ordering.

22. The method of claim 19, wherein the ordering of each indicator in at least one of the pairs of indicators is based on a first indicator of the at least one of the pairs of indicators associated with the first channel measurement resource of a first channel measurement resource group and a second indicator of the at least one of the pairs of indicators with the second channel measurement resource of a second channel measurement resource group, the first channel measurement resource group and the second channel measurement resource group comprising the channel measurement resource set.

23. The method of claim 19, wherein the ordering of each indicator in the at least one of the pairs of indicators is based at least in part on an order of appearance of the first channel measurement resource and the second channel measurement resource in the channel measurement resource set.

24. The method of claim 19, wherein the ordering of each indicator in the at least one of the pairs of indicators based at least in part on respective values of a first channel state information reference signal resource identifier associated with the first channel measurement resource and a second channel state information reference signal resource identifier associated with the second channel measurement resource.

25. A method for wireless communications at a base station, comprising:
transmitting, to a user equipment (UE), an indication of a first channel measurement resource and a second channel measurement resource, each configured for measuring channel state information reference signals at the UE, the first channel measurement resource associated with a first transmission configuration indicator state and the second channel measurement resource associated with a second transmission configuration indicator state;
transmitting, to the UE, a configuration for measuring channel state information reference signals for a first channel state information report that includes a first single transmission hypothesis associated with the first channel measurement resource, a second channel state information report that includes a second single transmission hypothesis associated with the second channel measurement resource, and a third channel state information report that includes a joint transmission hypothesis associated both a third channel measurement resource and a fourth channel measurement resource;
receiving, from the UE, uplink control information comprising the first channel state information report, the second channel state information report, and the third channel state information report ordered based at least in part on association of respective channel state information with either single transmission or joint transmission hypotheses.

26. The method of claim 25, wherein receiving the uplink control information further comprises:
receiving the first channel state information report and the second channel state information report in a first portion of the uplink control information or receiving the third channel state information report to the first portion of the uplink control information.

27. The method of claim 26, further comprising:
receiving the first channel state information report and the second channel state information report in an order that based at least in part on corresponding channel state information reference signal resource indicator values, wherein the channel state information report corresponding to a lowest channel state information reference signal resource indicator value is first in the ordering.

28. The method of claim 26, further comprising:
receiving the first channel state information report and the second channel state information report in an order that is based at least in part on corresponding channel measurement resource groups for the channel state information reports, wherein the channel state information report associated with the first channel measurement resource group is first in the ordering.

29. The method of claim 26, further comprising:
receiving the first channel state information report and the second channel state information report in an order that is based at least in part on corresponding channel state information reference signal resource ID values, wherein the channel state information report corresponding to a lowest channel state information reference signal resource ID value is first in the ordering.

30. The method of claim 25, further comprising:
receiving the channel state information reports in an order that is first based on an order of the respective transmission hypothesis in the uplink control information, and second based on alternating sub-bands of the channel state information reports.
